(19) United States
(12) Patent Application Publication
(10) Pub. No.: US 2024/0260526 A1
(43) Pub. Date: Aug. 8, 2024

(54) Grow Systems for Aeroponic and Hydroponic Plant Development

(71) Applicant: New AeroFarms, Inc., Ringgold, VA (US)

(72) Inventors: Mark Ira Rosen, Franklin Lakes, NJ (US); Carl Stephen Howarth, Camp Hill, PA (US)

(73) Assignee: New AeroFarms, Inc., Ringgold, VA (US)

(21) Appl. No.: 18/682,402

(22) PCT Filed: Aug. 10, 2022
(86) PCT No.: PCT/US2022/039950

§ 371 Date: Feb. 8, 2024

Related U.S. Application Data
(60) Provisional application No. 63/231,905, filed on Aug. 11, 2021.

(51) Int. Cl. A01G 31/06; A01G 7/04

(52) U.S. Cl. CPC A01G 31/06; A01G 7/045

(57) ABSTRACT

Disclosed herein are grow systems for developing plants using aeroponic and hydroponic techniques. The grow system includes a frame, lighting supports, and container skirts for positioning growing containers in the grow system. The container skirts simplify methods of installing or removing growing containers from the grow system without using tools, improves container drainage, and captures nutrient solution spillage when containers are removed from the grow system. The configuration of the grow system allows lighting supports and container skirts to horizontally extend past vertical members of the frame which improves access to plants and grow system lighting.

### CROSS-REFERENCE TO RELATED APPLICATIONS

This application claims the benefit of a co-pending, commonly assigned U.S. Provisional Patent Application No. 63/231,905, which was filed on Aug. 11, 2021. The entire content of the foregoing provisional application is incorporated herein by reference.

### TECHNICAL FIELD

This disclosure relates generally to modular aeroponic and hydroponic grow systems that are easy to use and easy to maintain.

### BACKGROUND

Aeroponic and hydroponic grow systems generally contact plant roots with a nutrient solution, recycle the nutrient solution, and provide lighting of suitable frequency and intensity to develop the plants. Nutrient solution spilled on grow system surfaces, such as drip pans and growing containers, during use may develop biofilms and/or algae, and need to be cleaned for growing plant health and food safety. In some instances, growing containers can be cleaned in place following plant development. However, this can be cumbersome, especially in multilevel or stacked growing systems. Containers that can be removed from the growing system for cleaning need to have nutrient delivery and drain fittings broken and remade to allow for proper cleaning. The containers may hold residual amounts of nutrient solution that can spill onto lighting fixtures, onto grow system surfaces, and onto personnel when the containers are removed from the grow systems. For containers supported by the top rim of the container, the container generally needs to be lifted at least the height of the container depth to remove it from the grow system framework.

As controlled environmental agriculture continues to expand, there is a need for small aeroponic/hydroponic units that can grow volumes of plants for supply of fresh produce in settings such as schools, cafeterias, and grocery stores. Low cost growing systems that are food safe, easy to maintain, easy to clean, and that provide convenient access to the crops can be beneficial for customers and students. As such, there exists a continuing need for improved systems and methods for aeroponic and hydroponic grow systems that facilitate plant growing and cleaning operations.

### SUMMARY

The embodiments disclosed herein meet these and other needs by providing aeroponic, hydroponic, and nutrient film technique grow systems that can include growing containers for developing plants. The growing containers can have a solution inlet adapted for a fluid coupling connection to a nutrient solution supply fitting and drain lines located at or near a rear skirt end wall of the grow system. The nutrient supply connection can be made when the container is positioned between a front side skirt lip and a rear side skirt end wall of the grow system. When the container is positioned between the front side skirt lip and the rear side skirt end wall of the grow system, a container drain opening through the bottom wall or a side wall of the container can be positioned nearby and can be physically separated from an upper surface of the skirt that has a skirt drain. The skirt drain can return nutrient solution from the container into a nutrient supply return line of the grow system.

The growing container can be removed from between the front side skirt and rear side skirt end wall of the grow system by lifting and pulling the container toward the grow system front and atop the upper surface of a front skirt lip. By lifting the container over the front side skirt lip and onto the top surface of the front skirt lip to remove the growing container from the growing system, the growing container bottom surface can be held in a tilted position and residual used nutrient solution or water in the container can be directed to the container drain port. The rear of the skirt can have a ramp or raised region that can direct liquid to a rear skirt drain portion. The skirt raised region or skirt ramp can have a height above the skirt bottom surface at the skirt drain opening such that the height of the raised region can offset the container bottom from the skirt bottom surface and create a gap between a container drain or container drain downspout and the skirt drain opening. The rear skirt drain portion directs residual nutrient solution from the container as it drains or that spills onto the rear portion of the skirt upper surface towards the rear skirt drain where it can be returned to the nutrient supply return line. The physical separation of the container drain and/or drain downspout from the upper surface rear surface of the skirt can eliminate the need to physically break a drain fluid seal connection to remove the container from the grow system or eliminate the need to remake a drain fluid seal connection when the container is repositioned back in the growing system. This greatly facilitates and simplifies growing container removal from the grow system, container cleaning outside of the grow system, and container replacement in the grow system.

The rear of the skirt having a raised region or ramp, a tapered drain portion, or any combination of these, can catch nutrient solution as the growing container is removed from the grow system, thereby protecting lighting, growing system surfaces, and system operators from contact with residual nutrient solution. In some embodiments, the skirt can be a unitary skirt with a front skirt portion and a rear skirt portion. In some embodiments, the skirt can include a separate front skirt and a separate rear skirt. The front skirt and the rear skirt can be separate pieces that are positioned apart from each other in the grow system. Separate front and rear skirts can be less costly and more easily replaced and cleaned than longer unitary single skirts.

The grow containers can be removed from between the front side skirt and rear side skirt end wall of the grow system by lifting the growing container by less than a quarter of the container's height above the skirt lip and pulling or moving the container toward the front of the grow system and atop the upper surface of the front skirt lip. By lifting the container over the front skirt lip and onto the top surface of the front skirt lip to remove the growing container from the growing system, the container bottom surface can be left on the skirt lip and the container is supported in a tilted position that can help drain and any residual nutrient solution or water in the growing container to the container drain opening before the container is removed. Draining of the growing containers prior to their removal from the grow system helps to minimize spillage of residual nutrient solution and/or water in the containers and makes the containers lighter for removal and handling.

Embodiments of the disclosure can include a grow system for developing plants using aeroponic, hydroponic, and nutrient film techniques. The grow system can include a grow system frame comprising a top side, a bottom side, a right side, a left side, a front side, and a rear side. The growing system frame can have one or more vertical member(s) and one or more horizontal member(s) (e.g., vertical and horizontal relative to a ground plane). The vertical member(s) and the horizontal member(s) can be connected or coupled together to support one or more levels of growing containers and one or more levels of lighting lamps (e.g., lighting units). The growing containers can extend horizontally past the vertical members of the grow system frame that support the lighting lamps and lighting frames. The lighting lamps and lighting frame can extend horizontally past the vertical members of the grow system frame and can extend over the growing containers. The grow system can include one or more skirts positioned atop the horizontal member(s). The horizontal members connect the opposite sides (e.g., the right side and the left side or the front side and the rear side) of the growing frame together. The one or more skirts can support the growing containers between a front side skirt lip, opposing skirt sides, and a rear side skirt end wall. The rear skirt end wall can include a nutrient port that can mechanically and fluidly connect with a container nutrient inlet port.

The one or more skirts can include a skirt drain through a skirt bottom surface or through lower skirt side walls near the rear skirt side end wall. A growing container can be supported by the one or more skirts. The one or more skirts can have a raised region or a skirt ramp. The raised region or skirt ramp can have a height that may be measured between a top of the skirt raised region or ramp and the skirt bottom surface at the skirt drain opening. The raised region or skirt ramp can have a height above the skirt bottom surface at the skirt drain opening that can offset the container bottom from the skirt bottom surface and create a gap between the container drain or container drain downspout and the skirt drain opening. The skirt raised region or ramp can span between skirt sides and can have a front side facing surface and a skirt drain facing surface. The skirt ramp can be positioned between the opposing skirt side walls, the front side skirt lip and the rear side skirt end wall. A growing container drain opening through a container wall (e.g. bottom wall or side wall) can be positioned between the rear side skirt end wall and the drain facing surface of the skirt raised region when the container is positioned or installed between the front side skirt lip, the opposing skirt sides, and the rear side skirt end wall.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

A more complete understanding of the present disclosure and the advantages thereof may be acquired by referring to the following description, taken in conjunction with the accompanying drawings in which like reference numbers indicate like features and wherein:

FIG. 1 is a perspective view of an exemplary grow system of the disclosure that can include one or more grow levels.

FIG. 2 is a perspective view of an exemplary grow system of the disclosure that can include one or more grow levels.

FIG. 3 is a perspective view of an exemplary grow system of the disclosure.

FIG. 4 is a detailed, perspective view of an exemplary grow system of the disclosure.

FIG. 5 is a detailed, perspective view of an exemplary grow system of the disclosure.

FIG. 6 is a cross-sectional, perspective view of a portion of an exemplary grow system of the disclosure.

FIG. 7A is a cross-sectional, perspective view of a growing container of an exemplary grow system positioned between a skirt front lip, a skirt rear wall, and one or more side skirt(s), and FIG. 7B is a cross-sectional perspective view of a growing container of an exemplary grow system positioned between a skirt front lip, a skirt rear wall, and one or more side skirt(s).

FIG. 8 is a cross-sectional, perspective view of a front portion of a skirt and growing container of an exemplary grow system of the disclosure.

FIG. 9 is a cross-sectional, perspective view of a rear portion of a skirt and growing container of an exemplary grow system of the disclosure.

FIG. 10A and FIG. 10B are cross-sectional front and perspective views illustrating positioning of grow containers for removal from an exemplary grow system of the disclosure or for installation of grow containers into an exemplary grow system of the disclosure.

FIG. 11A is a front view of an exemplary grow system of the disclosure including grow containers, container skirts, lighting lamps and lighting support frames, and FIG. 11B is a front view of the exemplary grow system of FIG. 11A without lighting lamps, containers, and skirts.

FIG. 12A is a rear view of an exemplary grow system of the disclosure including grow containers, container skirts, lighting lamps and lighting support frames, and FIG. 12B is a rear view of the exemplary grow system of FIG. 12A without lighting lamps, containers, and skirts.

FIG. 13A is a top view of an exemplary grow system of the disclosure including growing trays, and FIG. 13B is a simplified top view of the exemplary grow system of FIG. 13A without the growing trays.

FIG. 14 is a right side view of an exemplary grow system of the disclosure.

FIG. 15 is a left side view of an exemplary grow system of the disclosure.

FIG. 16A is a bottom view of an exemplary grow system of the disclosure, and FIG. 16B is a simplified bottom view of the exemplary grow system of FIG. 16A.

### DETAILED DESCRIPTION

In the following description, it is understood that terms such as “top,” “bottom,” “outward,” “inward,” and the like are words of convenience and are not to be construed as limiting terms. Reference will now be made in detail to embodiments of the disclosure, which are illustrated in the accompanying description, figures, and examples. Referring to the drawings and figures in general, it will be understood that the illustrations are for the purpose of describing particular embodiments of the disclosure and are not intended to limit the same. Whenever a particular embodiment of the disclosure is said to comprise or consist of at least one element of a group and combinations thereof, it is understood that the embodiment may comprise or consist of any of the elements of the group, either individually or in combination with any of the other elements of that group.

Approximating language, as used herein throughout the specification and claims, may be applied to modify any quantitative or qualitative representation that could permissibly vary without resulting in a change in the basic function to which it is related. Accordingly, a value modified by a term such as “about” or numerical ranges is not to be limited to a specified precise value and may include values that differ from the specified value. In at least some instances, the approximating language may correspond to the precision of an instrument for measuring the value.

Embodiments of the disclosure include a grow system for developing plants. In embodiments of the disclosure, the term “developing plant(s)” can refer to one or more germinating seeds, one or more seedlings with or without true leaves, one or more growing plants, or any combination of these that are on a generally top surface of a growth medium. Lighting that can be used for developing plants in the grow system can include high pressure sodium lamps, incandescent lamps, fluorescent lamps, and light emitting diodes (LEDs), or any combination of these. The lighting lamps can be chosen to provide suitable frequency, wavelength and intensity of light for plants that are being developed in the system. A nutrient solution and/or water can be used to feed the plants during their development. Hoagland's solution is an example of a nutrient solution that can be used for developing various plants. The nutrient solution and/or water can be stored in a tank and can be recirculated to one or more growing containers in the grow system. The growing containers can accommodate trays and growth media. In some embodiments the growing containers can have a substantially constant depth. In other embodiments the container can have a varying depth across their length and/or width to facilitate movement of liquid in the container towards the container drain when the container is positioned in the grow system. Various growing media can be used to grow and support the plants in the grow system. Grow media can include soilless grow media, such as rock wool, cloth, perlite, and the like.

Embodiments of the disclosure can include a grow system that can have a grow system frame that includes a top side, a bottom side, a right side, a left side, a front side, and a rear side. The growing system frame can have one or more vertical member(s) and one or more horizontal member(s). The vertical member(s) and the horizontal member(s) can be connected together to support one or more levels of growing containers and one or more levels of lights. In embodiments of the disclosure the growing containers can extend horizontally past the vertical members of the grow system frame that support the lighting lamps and lighting frames. The lighting lamps and lighting frame can extend horizontally past the vertical members of the grow system frame that support them and can extend over the growing containers. This extension of the growing containers, the lighting frames, and the lighting lamps beyond the vertical members improves access to the developing plants and grow system components by eliminating obstructions at the corners of the growing containers.

The grow system can include one or more skirts. The skirts can have a unitary structure in some embodiments or can be comprised of two or more sections. For example, the skirt can include a front skirt section and a rear skirt section, and the front skirt and rear skirt can be separated from each other in the grow system by a gap. The skirts can have a front skirt portion and a rear skirt portion and the one or more skirts can be positioned atop one or more of the horizontal member(s) that connect the opposite sides (e.g., the right side and the left side or the front side and the rear side) of the growing frame together. The unitary skirts or the one or more front skirts and the rear skirts can support the growing containers between a front skirt lip, opposing skirt sides, and a rear skirt end wall. The rear skirt end wall comprises a nutrient port that can fluidly connect with a container nutrient inlet port. In embodiments of the disclosure the one or more skirts that support the growing containers can extend horizontally past the vertical members of the grow system frame that support the lighting lamps and lighting frames.

The one or more skirts of the grow system can include a skirt drain through a skirt bottom surface or one of the lower skirt side walls near a rear skirt end wall. The one or more skirts can have a raised region or a skirt ramp, the raised region or skirt ramp can have a height that may be measured between a top of the skirt raised region or ramp and the skirt bottom surface at the skirt drain opening. The skirt raised region or skirt ramp can have a height above the skirt drain opening that can offset the container bottom in the grow system from the skirt bottom surface that can create a gap between the container drain or container drain downspout and the skirt drain opening near the rear skirt end wall. This gap allows nutrient solution in the container to drain into the nutrient return line of the grow system without the need for a fluid coupling between the container and drain line that has to be made and broken when the container in installed or removed from the grow system (as is generally needed in traditional grow systems). The raised region or skirt ramp can be positioned near the rear skirt side of the one or more skirts. The skirt raised region or skirt ramp can span between the skirt sides at the rear of the skirt and can contain liquid between the skirt sides, the raised region, and the rear wall of the skirt. The raised region or ramp near the rear of the skirt and can have a side that faces the front lip of the skirt or front skirt and the raised region can have a side that faces skirt drain of the skirt or rear skirt and the rear skirt wall surface. The drain facing surface of the raised skirt region can further include a channel that can slope toward the skirt drain. The channel can accommodate and allow clearance of a container drain downspout as a growing container is positioned between one or more skirts. The front lip facing side of the raised region can also include a channel that can accommodate and allow clearance of the container downspout.

The skirt raised region or skirt ramp can be positioned between the opposing skirt side walls, the front side skirt lip and the rear side skirt end wall. In the grow system, a growing container drain opening through a container wall or a container floor of the growing containers can be positioned between the rear skirt end wall and the drain facing surface of the skirt ramp when the container is positioned between the front skirt lip, the opposing skirt sides, and the rear skirt end wall.

In some embodiments the grow system can include a front skirt that is spaced apart from the rear skirt and the front skirt and rear skirt can be positioned separately within the growing system frame.

Some embodiments of the grow system of the disclosure can include a grow system frame comprising a top side, a bottom side, a right side, a left side, a front side, and a rear side. The growing system frame includes one or more vertical member(s) and one or more horizontal member(s). The vertical member(s) and horizontal member(s) can be connected together to support one or more levels of lighting lamps and one or more levels of container skirts which can be adapted to hold growing containers. In the grow system, the one or more levels of lighting lamps, lighting lamp frames, and the one or more levels of skirts can extend horizontally past the vertical members of the grow system frame that support the lighting lamp frames. Extending the lamps, lamp frames, and skirts past the vertical members of the grow system that support the lamp frames can facilitate and improve access to plants and equipment in the grow system. The one or more container skirts can be positioned atop the grow system horizontal member(s) that connect the opposite sides (e.g., the right side and the left side or the front side and the rear side) of the growing frame together. The one or more skirts adapted to support the growing containers can have a front side skirt lip, opposing skirt sides, and a rear side skirt end wall. The rear skirt end wall may support a nutrient port adapted to fluidly connect to a container nutrient inlet port. The one or more skirts include a skirt drain opening through a skirt bottom surface near the rear side skirt end wall. The one or more skirts can include a skirt raised region or skirt ramp between the side skirts that is adapted to contact a bottom surface of the growing container. The skirt raised region has a height above the skirt bottom surface at the skirt drain opening. The height of the skirt raised region can be below the top surfaces of the side skirts. The height of the skirt raised region can be adapted to support the container and create a gap between the skirt drain opening and the bottom surface of a growing container when the container is positioned between the front side skirt lip, the side skirts, and the rear side skirt end wall.

In some embodiments of the grow system of the disclosure the front side of the one or more skirts can be vertically positioned higher than the vertical position of the rear side of the one or more skirts in the grow system. In some embodiments, the one or more skirts can include both a front lip and a rear wall. In other embodiments of the disclosure the one or more skirts can be pairs of a front skirt with a front lip and a rear skirt that can include a rear end wall and a raised region, and the front skirt and the rear skirt can be separated from each other by a gap.

In some embodiments of the grow system of the disclosure, growing containers can be supported and positioned by the skirts or container skirts. The growing container can have a growing container drain opening through the bottom surface of growing container. When the container is positioned between a skirt rear end wall and a skirt front lip, the growing container drain opening can be positioned near and separated from the skirt drain opening. The growing containers can extend horizontally past the vertical members of the grow system frame that support the lighting frames of the grow system. The container skirts can extend horizontally past the vertical members of the grow system frame that support the lighting frames of the grow system.

Still other embodiments of the disclosure can include a skirt adapted for a growing container in a grow system. The skirt can include a front side skirt lip, opposing skirt sides, and a rear side skirt end wall. The skirt can further include a drain opening through a skirt bottom surface near the rear side skirt end wall. The skirt can include a raised portion or region between the skirt rear end wall, side skirts, and front side skirt lip. The drain opening can be located between the rear end wall and raised region. The raised region can contain liquid between the skirt rear end wall, side skirts, and the raised portion and can facilitate transport of the liquid to the drain opening. In some embodiments, the raised portion or region of the skirt can include a downward sloping surface toward the drain opening that can facilitate draining of liquid that can leak into the skirt when fluid connections between the container fitting and nutrient line fitting are made or broken. The raised region between the side skirts, the front lip, and the rear wall can be adapted to contact surfaces of the growing container. The skirt raised region can be characterized as having a height above the skirt bottom surface at the skirt drain opening. The height of the skirt raised region can be adapted to create a gap between the skirt drain opening and the bottom surface of the container at the container drain opening when a growing container is positioned between the front side skirt lip, the rear side skirt end wall, and side skirts. In some embodiments of the disclosure the skirt can have a front skirt portion and a separate rear skirt portion, the front skirt portion includes the front side skirt lip and the rear skirt portion can include the rear skirt end wall, skirt drain opening, and the raised region. In some embodiments of the disclosure the front skirt portion and the rear skirt portion can be physically separated from each other in the grow system frame.

Aspects of the disclosure will be better appreciated and understood when considered in conjunction with the following description and the accompanying drawings. Throughout the various views and illustrative embodiments, like reference numbers are used to designate like elements. The following description, while indicating various embodiments of the disclosure and numerous specific details thereof, is given by way of illustration and not of limitation. Many substitutions, modifications, additions or rearrangements may be made within the scope of the disclosure, and the disclosure includes all such substitutions, modifications, additions or rearrangements.

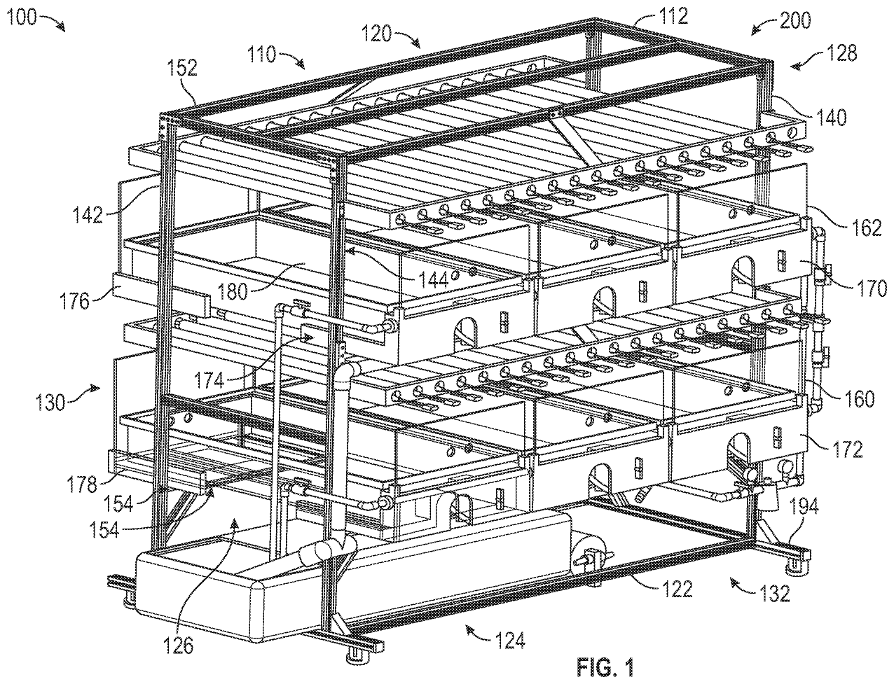

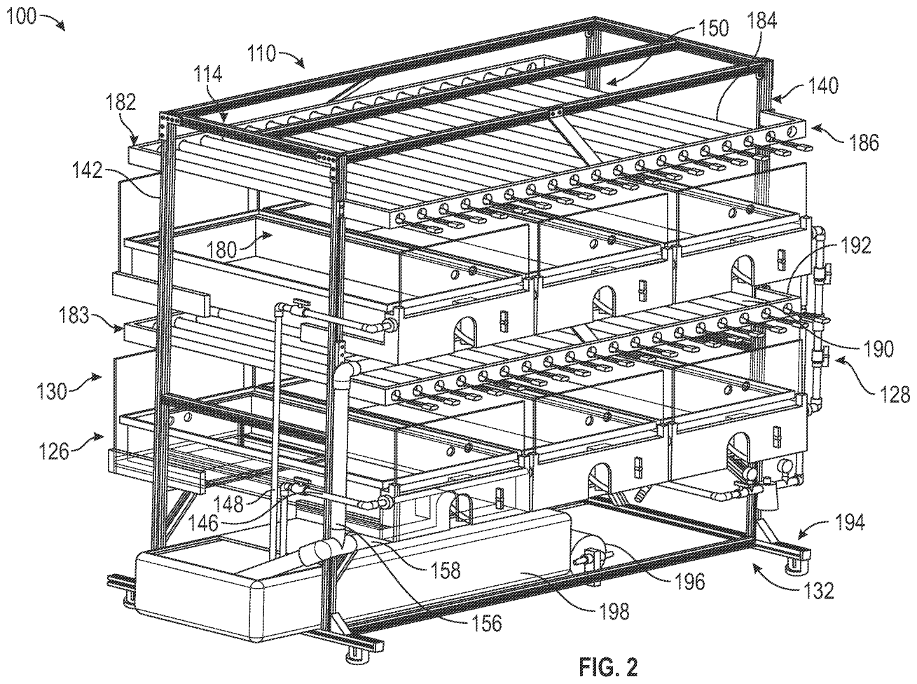

FIG. 1 and FIG. 2 illustrate perspective views of a grow system 100 that can have one or more grow levels in an embodiment of the disclosure. For example, the grow system 100 of FIGS. 1 and 2 includes two grow levels vertically disposed relative to each other. However, the grow system 100 can be configured and dimensioned to include one grow level or more than two grow levels. The grow system 100 can include a grow system frame 110 that can have a top side 120, a bottom side 124, a right side 126, a left side 128, a front side 130, and a rear side 132. The growing system frame 110 can include vertical framing members and horizontal framing members. Vertical members (such as but not limited to 140, 142, 144, and 150) can be connected to horizontal framing members (such as but not limited to 112, 114, 122, 152, 154, and others not shown). The vertical framing members can support the lighting frames 186 and 192 of the grow system. The growing containers 180 can extend horizontally past the vertical members of the grow system frame that support the lighting frames of the grow system. The container skirts can extend horizontally past the vertical members of the grow system frame that support the lighting frames of the grow system. For example, the growing containers 180 and container skirts can extend horizontally past vertical planes defined by the vertical members. In some embodiments, the growing containers 180 and container skirts can extend horizontally past vertical planes defined by the vertical members at both the front and rear sides 130, 132 of the grow system frame 110. The horizontal members connected to the vertical members can support the skirts and the containers. The horizontal members can connect the front side 130 and rear side 132 of the grow frame together and can connect the right side 126 and left side 128 of the grow frame together.

As FIG. 1 and FIG. 2 illustrate, growing container(s) 180 can be positioned between one or more front and rear skirts. The growing container 180 can be positioned between a front lip of the front skirt 176 and an end wall of the rear skirt 174. The growing containers positioned between the front lip and rear skirt wall can extend horizontally past the grow frame vertical members such as 140, 142, 144, and 150 of the grow system frame. The one or more skirts, for example the front skirts and rear skirts, can extend horizontally past the vertical members. For example, upper level 162 front skirts, such as front skirt 176, can extend horizontally past the grow frame vertical members 142 and 150 and the upper level 162 rear skirts, such as rear skirt 170 or rear skirt 174, can extend horizontally past the grow frame vertical members 140 and 144. Lower level 160 rear skirts, for example rear skirt 172, can extend horizontally past grow frame vertical members 140 and 144. Lower level front skirts, for example front skirt 178, can extend horizontally past grow frame vertical members 142 and 150. Lighting lamps (e.g. 190, 184) and lighting frames (e.g. 192, 186), can also extend horizontally past vertical members of the grow system frame in embodiments of the disclosure. For example, upper level lighting lamps 184 and support frames 182 and 186 can extend horizontally past vertical frame members 140, 142, 144, and 150. In each of the instances described herein regarding horizontal extension beyond the vertical members, it should be understood that such components generally extend beyond vertical planes defined by the vertical members.

The grow system frame 110 can support components of the grow system including growing containers, one or more skirts, lighting (e.g. 184, 190) and lighting frames (e.g. 182, 183, 186, and 192). The grow frame can support optional additional components including a nutrient solution pump 196, a nutrient tank 198, an electrical panel 188, or any combination of these. In some embodiments of the disclosure the growing system frame can include a lower base frame portion 194 and an upper frame portion 200. In some embodiments the upper frame portion can be centrally positioned with respect to the base frame portion. In some embodiments the base frame portion can be wider than the upper frame portion. The upper frame portion can support growing containers, one or more skirts, lighting lamps and lighting frames. The base frame portion can support a nutrient solution pump 196, a nutrient tank 198, and an electrical panel 188. Nutrient feed lines 146 and 148 can deliver nutrient solution and water to the containers 180. Drain lines 156 and 158 can return nutrient solution to the nutrient tank 198 from the growing containers. The base frame portion can provide stability and counterweight for the upper frame portion or the upper central frame portion thereby facilitating the positioning of growing containers, lighting and lighting frames, and one or more skirts horizontally past the vertical members of the upper frame portion or the central upper frame. Positioning growing containers and lighting past vertical members of the grow system frame or the central frame portion (e.g., past vertical planes defined by the vertical members) improves user access to the plants across the grow media, across adjacent grow containers, facilitates change out of lighting lamps, and allows users to observe nutrient delivery and root development throughout the containers. In some embodiments of the disclosure more than a quarter of the total length of adjacent grow containers can be accessed from any side of the grow system, including the corners of the grow system, without interference from any vertical member. In some other embodiments of the disclosure the total length of adjacent grow containers can be accessible from the front side, the rear side, and corners of the grow system without interference from any vertical member.

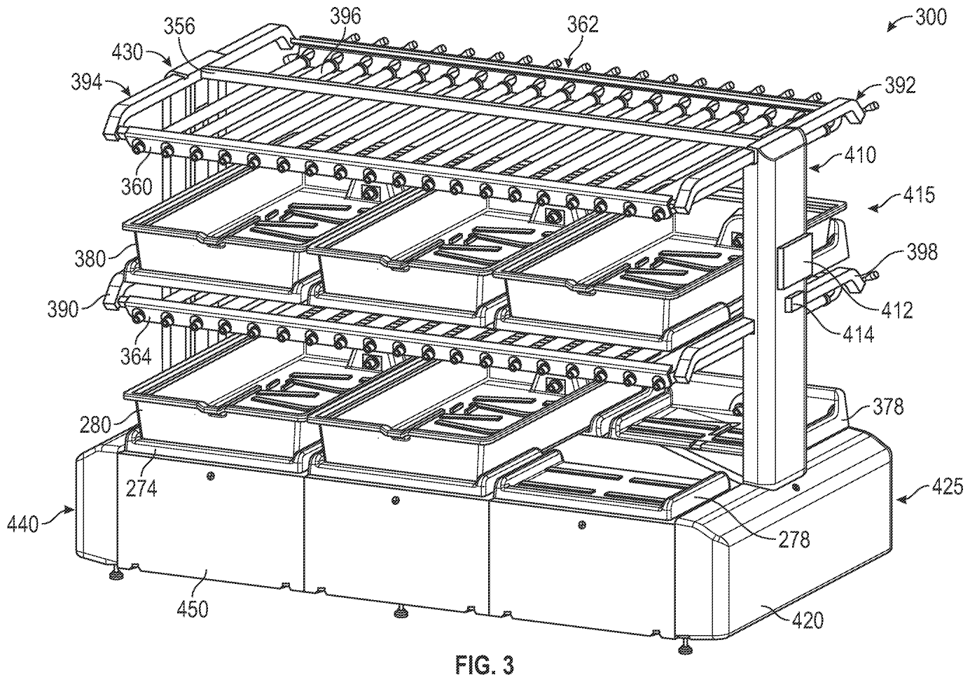

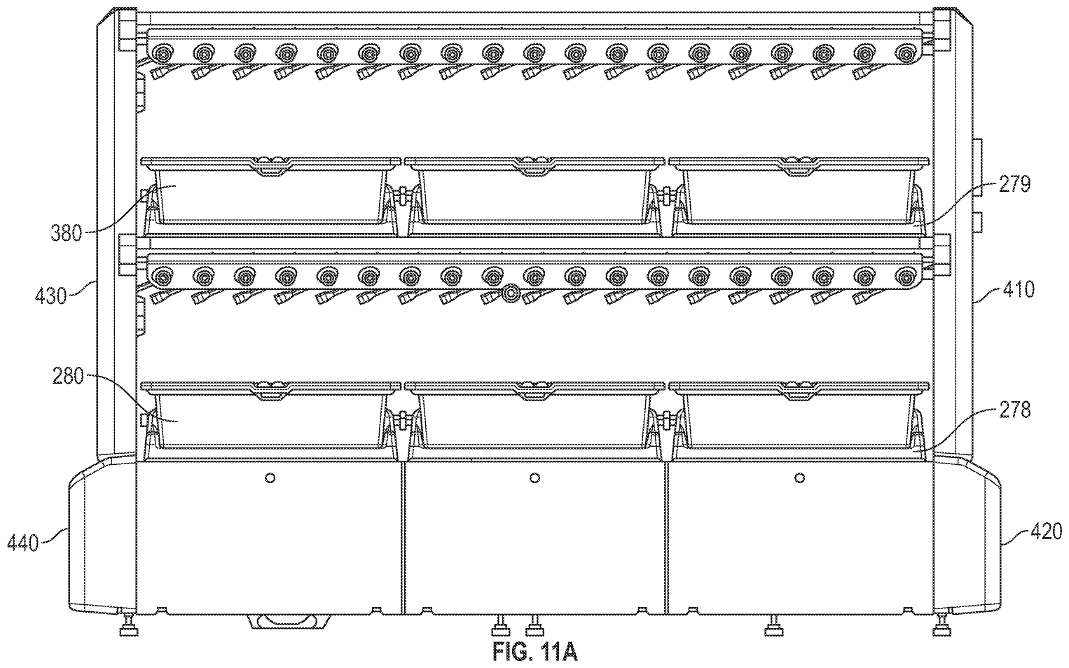

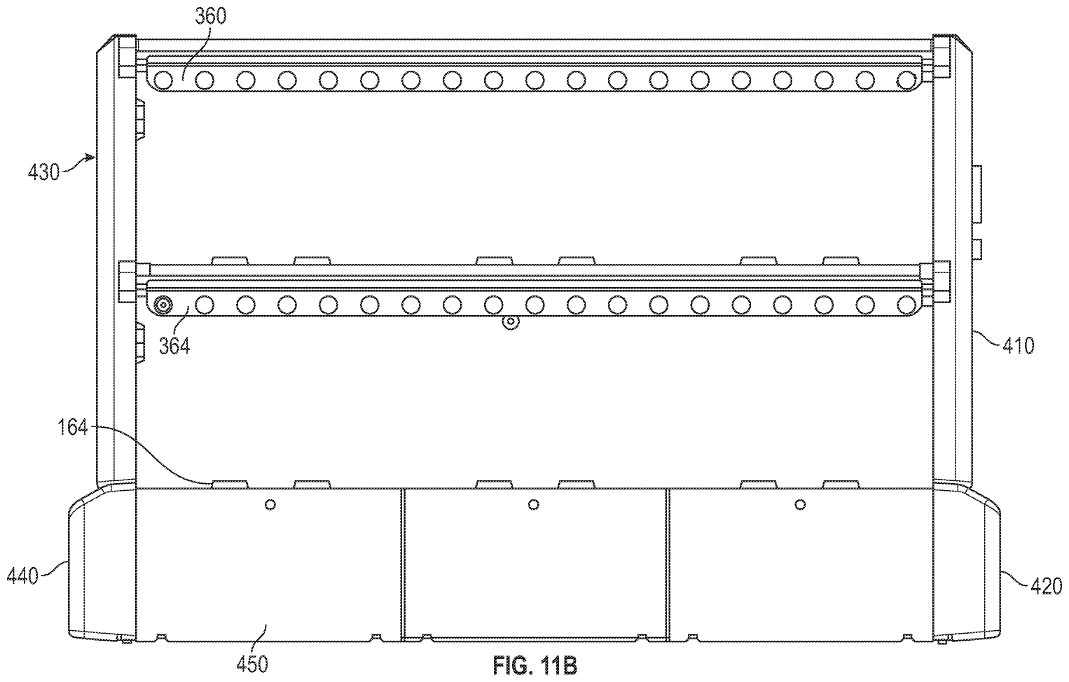

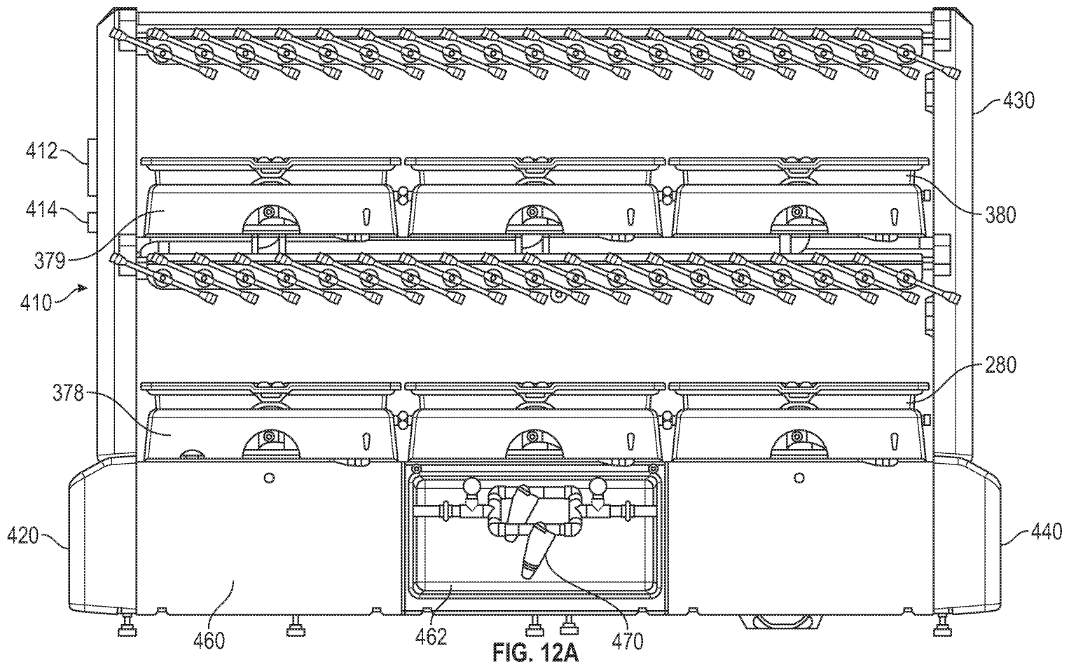

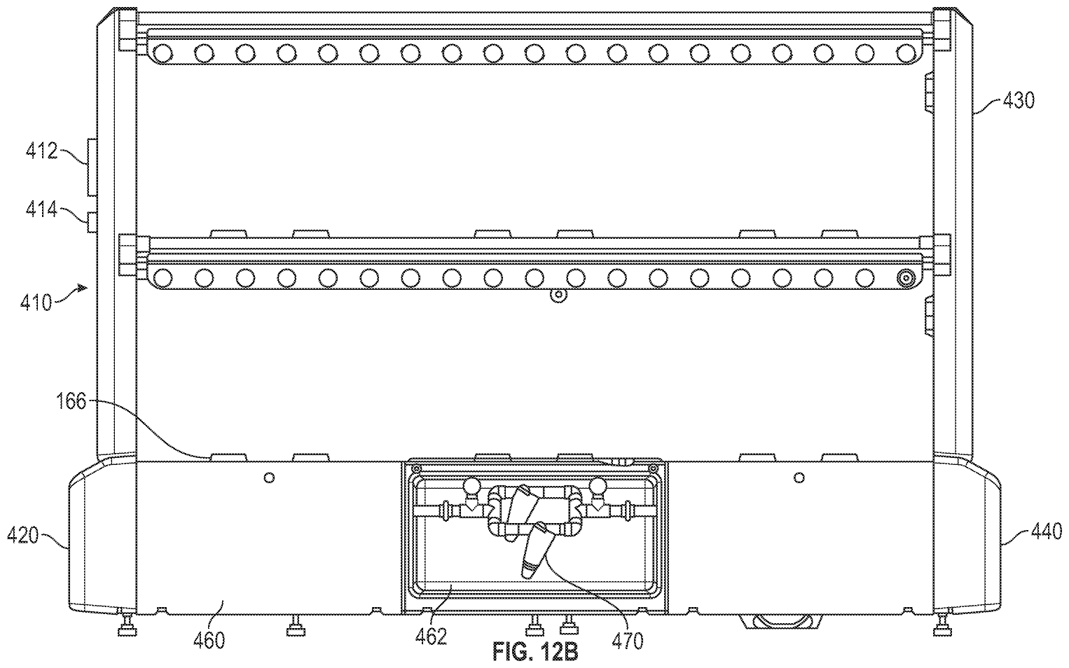

FIG. 3 is a perspective view of another embodiment of a grow system 300. The grow system 300 can include a grow system frame that can have a top side, a bottom side, a right side, a left side, a front side, and a rear side. The growing frame can include vertical framing members and horizontal framing members (e.g. such as but not limited to 356). Horizontal members can connect the front side and rear side of the grow frame together and horizontal members can connect the right side and left side of the grow frame together. The horizontal members can be connected to the vertical members and can support the container skirts, lighting, lighting frames, and the containers. The grow system 300 can have a base frame portion 425 and a central upper frame portion 415. The central upper frame portion 415 can be narrower in width than the base frame portion from front to rear of the grow system. The base frame portion 425 can be covered with panels 440, 450, 460, 462, and 420. The central upper frame portion 415 can be covered with panels 410 and 430. The grow system 300 can include lower level growing containers such as but not limited to 280, upper level growing containers such as 380, and each level can include one or more skirts such as but not limited to 274, 278, 279, 378, and 379 (see also FIG. 11A and FIG. 12A).

The grow system 300 can further include upper level lighting support frame members (e.g. 360, 362, 392, and 394), lower level lighting support frame members (e.g. 364, 390, and 398), and lighting lamps (e.g. 396). The grow system can further optionally include a nutrient solution pump 196, a nutrient tank 198, and an electrical panel 188. In some embodiments as illustrated in FIG. 3, the upper frame portion can be centrally positioned with respect to the base frame portion. In some embodiments the base frame portion can be wider than the upper frame portion. The upper frame portion can support growing containers, one or more skirts, lighting lamps, and lighting frames. The base frame portion can optionally support the nutrient solution pump 196, a nutrient tank 198, and an electrical panel 188. The growing containers positioned between the front skirt lip and rear skirt wall can extend horizontally past the central upper frame portion 415 of the grow system frame (e.g., beyond the vertical plane defined by the ends of the central upper frame portion 415). Lighting lamps (e.g. 396) and lighting frames (e.g. 392, 394) can also extend horizontally past central upper frame portion 415 and vertical members (covered by panels 410) of the grow system frame in embodiments of the disclosure (e.g., beyond the vertical plane defined by the ends of the vertical members). The growing containers can extend horizontally past the vertical members of the grow system frame that support the lighting frames (e.g., beyond the vertical plane defined by the ends of the vertical members). The lighting lamps and lighting frame can extend over the growing containers.

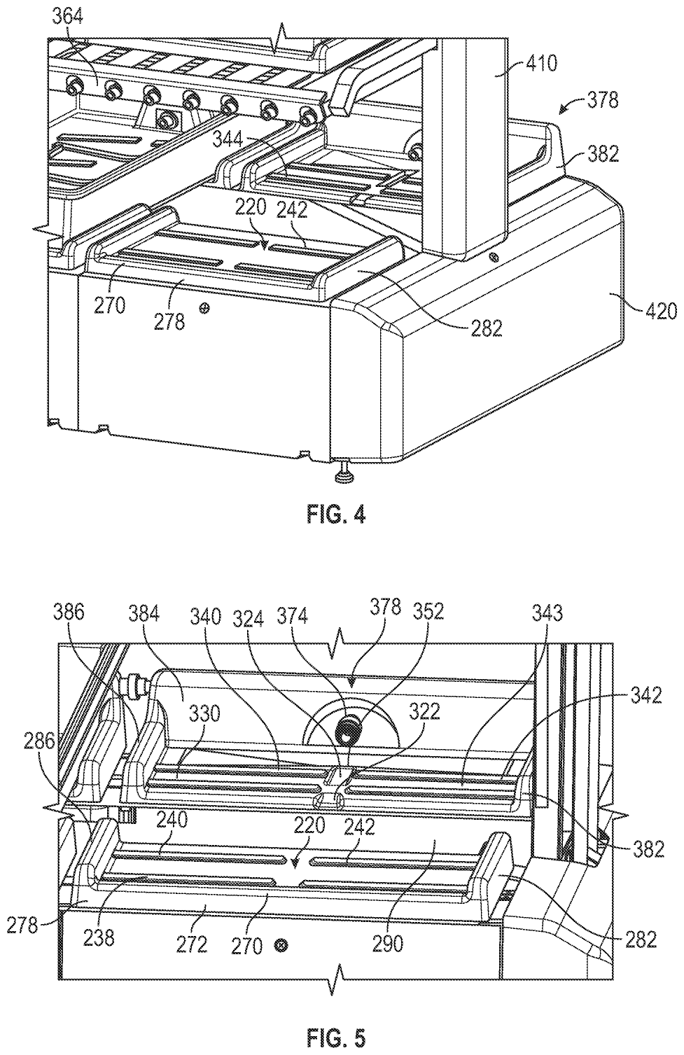

FIG. 4 is a close-up perspective view of one or more skirts 278 and 378 positioned on the lower level of the grow system 300 shown in FIG. 3. The skirt 278 can be positioned at the front side of the grow system and can include side skirts such as 282, a front lip top surface 270, stand-offs such as but not limited to 242 on a surface of the skirt, and a separation or gap 220 on a skirt bottom surface between stand-offs. The gap 220 can be sized to accommodate passage of a drain portion of a growing container. The skirt 378 can be positioned at the rear side of the grow system and can include stand-offs such as but not limited to 344 on a surface of the rear skirt and can include side skirts such as 382. In some embodiments the skirt 378 can be positioned at the rear side of the grow system and can include stand-offs such as but not limited to 344 on a raised surface 330 of the rear skirt and can include side skirts such as 382. Front skirt 278 can be physically separated from rear skirt 378 by a physical separation or gap 290 between the skirts (see, e.g., FIG. 5).

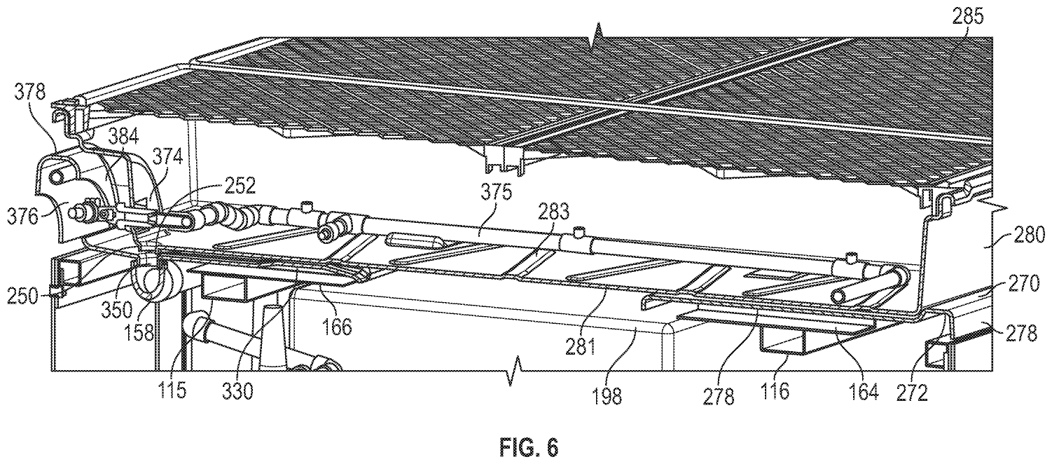

FIG. 5 is a further illustration of the one or more skirts in FIG. 4. The front skirt 278 can include one or more side skirts 282 and 286 and the rear skirt can include one or more side skirts 386 and 382. The side skirts can be continuous and extend a length of the skirt and/or the side skirts may consist of smaller spaced tabs along the length of the skirt. The spacing between the side skirts 282 and 286 and side skirts 386 and 382 allows positioning and proper alignment of a growing container in the grow system. Skirt 278 can include stand-offs such as but not limited to 238, 240, 242, and others on a surface of the skirt. Stand-offs such as 240 and 242 can be separated from one another by a gap 220 between the stand-offs wherein the gap is sized to allow clearance or passage of a container drain downspout across the skirt 278 and through the gap 220. The skirt 278 can include a front lip 272 that is raised above the surface of the skirt (e.g. FIG. 6) and that can have a front lip top surface 270. In embodiments of the disclosure a growing container such as growing container 280 can be positioned between the inside of the skirt front lip, the skirt rear wall, and between side skirts. In some embodiments a growing container such as growing container 280 can be positioned between the inside of the front lip 272 of a front skirt 278, the rear wall 384 of a rear skirt 378, and side skirts 282 and 286 and 382 and 386. The position of the container bottom 281 below the front lip 272 top surface 270 can indicate to a user when a growing container is fully engaged with a nutrient feed supply fluid coupling and when the container drain is aligned with or near the rear skirt drain. The top surface or ledge 270 of the front skirt lip can be used to tilt to a container when the container is positioned by a user to rest on the ledge 270 which facilitates container drainage of liquid before removal of the container from the grow system. The raised region 330 in the rear skirt or rear skirt portion can be set far enough back to allow the container drain to access the skirt drain even when container is pulled forward onto surface 270 which can help remove spilled solution from the grow system. In some embodiments of the disclosure the front skirt and rear skirt can be combined into a single skirt (without a gap) that can include a front facing side and front lip, a raised region, a rear facing side with a rear wall 384, a drain opening, and side skirts.

The rear skirt 378 or rear portion of a skirt can includes stand-offs such as but not limited to 340, 342, and the like, on a surface 343 of the rear skirt. The surface 343 can be part of the raised region 330. These stand-offs can be separated by a gap 324. In some embodiments the gap 324 can include a channel formed in the raised region 330 and the channel can be sized to allow passage of a drain downspout 252 of a container as it moves across the rear skirt or rear portion of a skirt during installation or removal from the grow system. The skirt can further include a front facing gap 322. The front facing gap 322 can have a channel formed and that can be sized to allow passage of a drain downspout of a grow container. Rear skirt 378 or a rear portion of a skirt can include a raised region 330 shaped as a ramp, dam, raised arch, or bump on the skirt and between the side skirts. The raised region 330 can extend between side skirts 386 and 382 and can be positioned to direct liquids towards the rear skirt drain opening 352. In some embodiments the height of the raised region 330 can be measured between a top surface of the raised region and the surface of the rear skirt drain at drain opening 352. In other embodiments the height of the raised region 330 can be measured between a top surface of stand-off 340 on the raised region and the surface of the rear skirt drain at drain opening 352. The front facing gap 322 and rear facing gap 324 can be formed into the raised region 330. The front facing gap 322 or channel and rear facing gap 324 or channel can have a slope and can be formed into and below the surface of the raised region 330. A fitting 374, for example but not limited to a quick connect fitting, can be located in the rear skirt 378 for mechanical and fluid connection to a complementary fitting 376 in fluid communication with a nutrient solution feed line (e.g. 146, 148). The container fitting 374 can provide nutrient solution to the inner volume of the container or to a manifold 375 within the container. The nutrient solution can feed plant roots aeroponically, hydroponically, by nutrient film technique (NFT), or any combination of these.

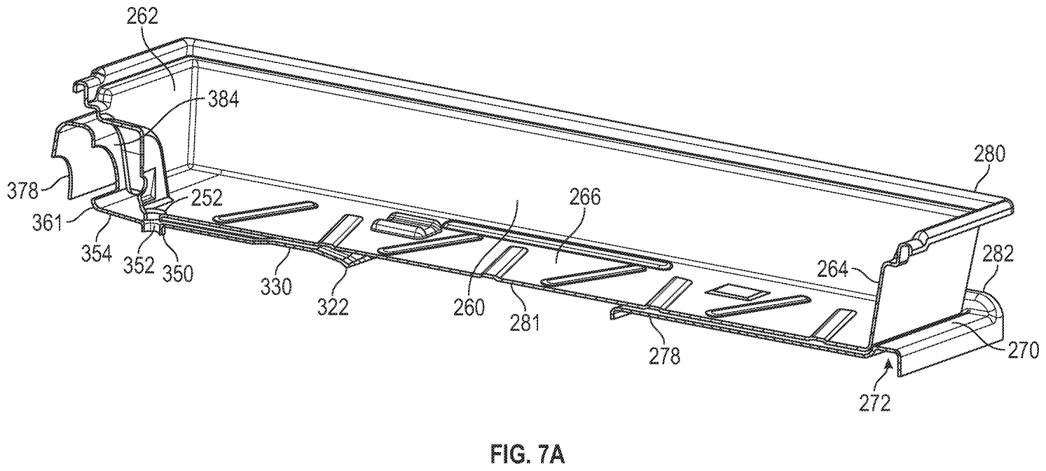

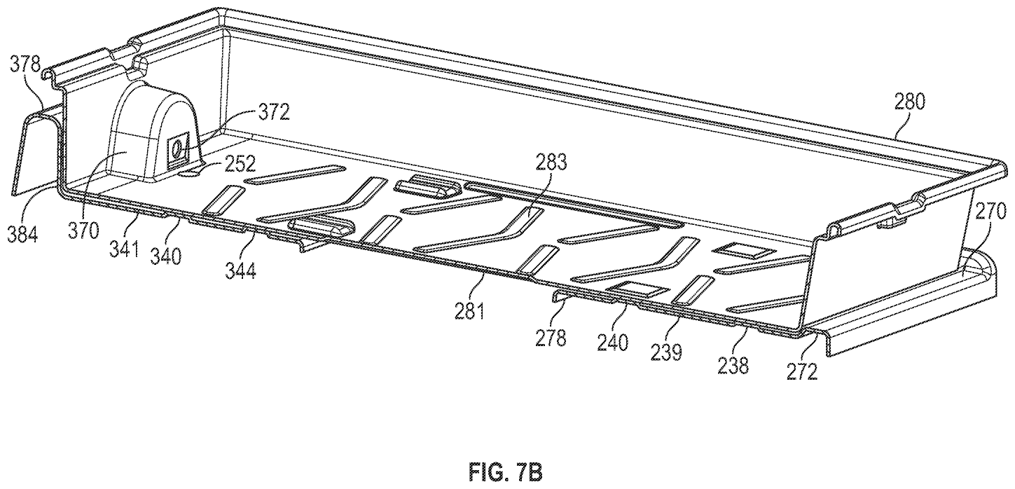

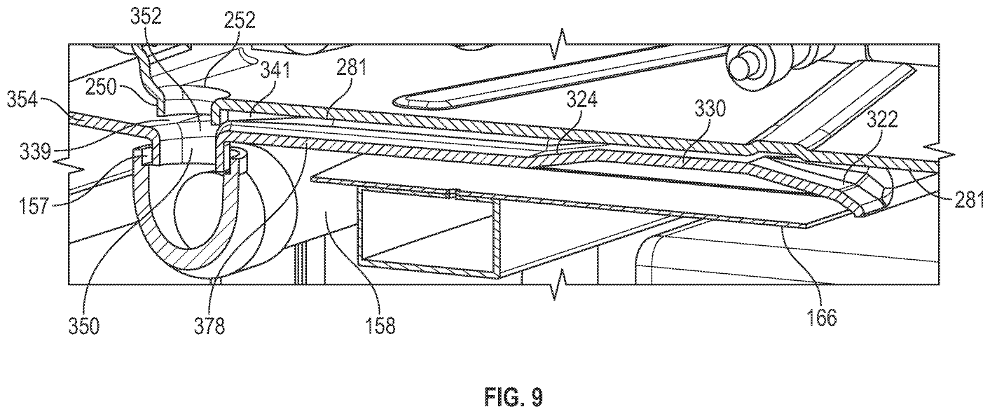

FIG. 6 is a cross sectional perspective view of a portion of the grow system including a container 280 positioned between a front side skirt lip 272 and a rear side skirt end wall 384. FIG. 6 shows a soilless growth media support tray 285 atop the container 280 and liquid nutrient supply line 375 for providing nutrient solution to plant roots in the container. The nutrient supply line 375 in the container 280 can be connected to the container fitting 374. The container fitting 374 can be coupled with a complementary fitting 376 within the skirt 378 that can be connected to a nutrient supply line (e.g. 146, 148) in fluid communication with the nutrient tank 198 and nutrient pump 196. The container 280 is shown positioned between the front side skirt lip 272 and rear side skirt end wall 384. The container fluid fitting 374 and complementary fitting 376 can be automatically fluidly coupled when container 280 is positioned between skirt lip 272 and rear end wall 384. The growing container 280 can have a drain opening 252, and an optional drain downspout 250. The growing container can include an inwardly directed raised structures 283 along the bottom of the container that can provide a tortuous path for liquid drainage from the container. Drain opening 252 and optional drain downspout 250 can be at least vertically separated by a gap 339 from the rear skirt drain opening 352 (see FIG. 5 and FIG. 9). Rear skirt drain opening and optional downspout 350 can direct nutrient solution into a nutrient return line 158. The bottom surface 281 of the growing container 280 is illustrated below the front side skirt lip top surface 270 when the growing container 280 is held between the skirt front lip, the rear skirt wall, and side skirts. The bottom surface 281 can contact the top facing surfaces of the skirts including one or more stand-offs (see, e.g., FIG. 7B). Front skirt portion or front skirt 278 can be supported on support plate 164 and horizontal framing member 116. Rear skirt portion or rear skirt 378 with raised region 330 can be supported on a support plate 166 and horizontal framing member 115.

FIG. 6 illustrates that when a growing container 280 is positioned in the grow system, the growing container drain opening 252 and/or container drain downspout 250 through the bottom surface or lower surface of the growing container 280 can be positioned overtop or nearby the skirt drain opening 352 and/or skirt drain downspout 350. The container drain opening 252 and/or container drain downspout 250 can be located between the rear side skirt end wall and the drain facing surface of the skirt raised region 330 when the container bottom is positioned between the front side skirt lip 272 (below skirt lip surface 270) and the rear side skirt end wall 384.

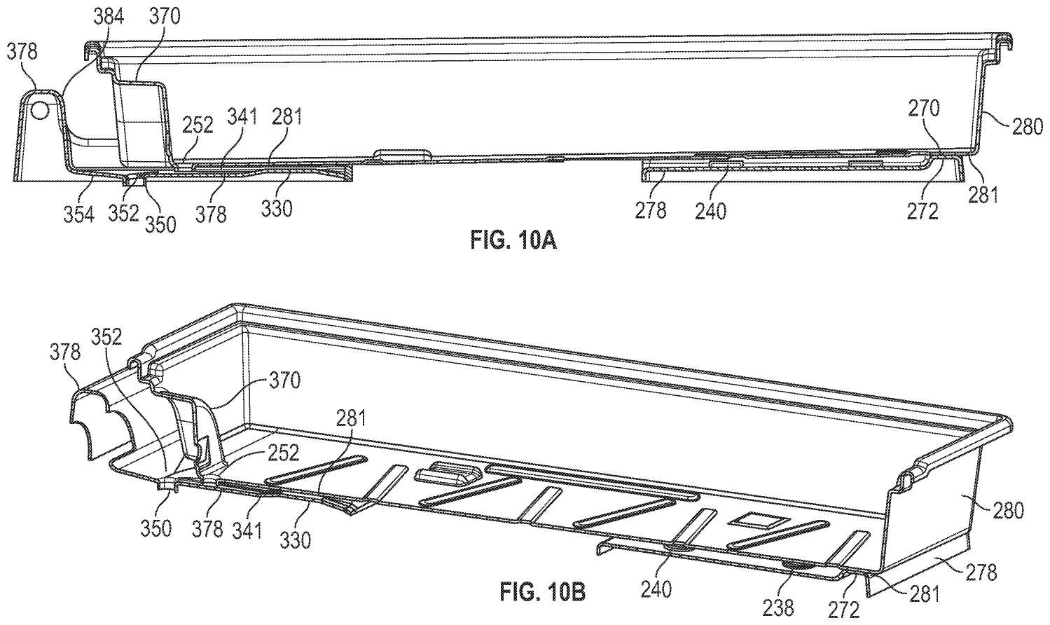

Growing containers such as 280 can include a front wall, a rear wall, side walls and a bottom floor. Ribbing 283 on the bottom floor can help create a tortuous path for liquid draining or traveling across the container bottom. The growing containers can be molded from various materials or can be assembled from component parts. To facilitate drainage of nutrient solution or water from the container, some embodiments of the container can have a slope from front to back with side walls that can have a corresponding tapered profile. The container front facing wall can be shorter than the rear facing wall. In some embodiments, the container can have a side-to-side slope to assist with nutrient solution or water drainage. The position of the one or more skirts can also be adjusted using support plates such as 164 and 166 or other spacers below the skirts to provide a slope to the container 280 from a vertically higher front to a vertically lower rear in the grow system. The front skirt or front portion of a skirt can be positioned at the same height or vertically higher that the position of the rear skirt or a rear portion of a skirt. The slope of the growing container bottom from the front wall down towards the rear wall in the grow system can be the result of the container having a sloped profile, the positioning of the one or more skirts from front to back, or any combination of these. In some embodiments of the grow system the container 280 can slope or tilt from a higher front to a lower back. For example, in some embodiments of the grow system, the container 280 can have a sloped profile by having an end wall 262 that is shorter than end wall 262 and tapered side walls. The container in the grow system can be tilted from front to back within the grow system by positioning the front of the skirt or front skirt vertically higher in the grow system than the rear of the skirt or rear skirt in the grow system. In some other embodiments of the grow system the container 280 can have a sloped profile from front to back or be tilted within the grow system from front to back by between about 0.5 degrees to about 2 degrees. The container can be removed from the grow system by lifting the container front wall above the height of the front lip, pulling the container forwards, and setting the container bottom 281 atop the front lip surface 270 (e.g. FIG. 10A). In some embodiments, the container 280 can have a sloped profile relative to the sides, e.g., sloping towards the drain opening 252 from one or both sides, to assist with drainage.

FIG. 7A is a cross sectional perspective view of a growing container 280 positioned between skirt front lip 272, skirt rear wall 384, and one or more side skirt(s) 282. Container rear wall 262 is positioned near or touching skirt rear wall 384, container front wall 264 is positioned near or touching skirt front lip 272, and container wall 260 is positioned near or touching side skirt 282. Rear skirt portion 378 can include a downward sloping surface 354 between the rear wall 384 and the skirt drain opening 352 that can facilitate draining of liquid that can leak when fluid connections between the container fitting 374 and nutrient line fitting 376 are made or broken. When growing container 280 is positioned between skirt front lip 272, skirt rear wall 384, and side skirt 282, container drain opening 252 through container bottom 266 is positioned near rear skirt drain opening 352 and rearward of rear skirt raised region 330. The rear skirt transition portion 361 between the rear skirt wall 384 and the downward sloping surface 354 can support container bottom surface 281 and help maintain the gap 339 between the skirt surface near the skirt drain opening 352 and the container drain opening 252 or container downspout 250.

FIG. 7B is a cross section of a container between skirts 278 and 378 illustrating skirt stand-offs. Growing container 280 bottom surface 281 can contact a top surface of raised offsets 238 and 240 of skirt 278 and container bottom surface 281 can contact a top surface of raised offsets or stand-offs 340 and 344 of skirt 378. Container bottom 281 can be separated from skirt bottom surfaces in regions by gaps without offsets such as 239 and 241. These gaps between the skirt surfaces and the container bottom can improve air circulation and temperature uniformity in the grow system.

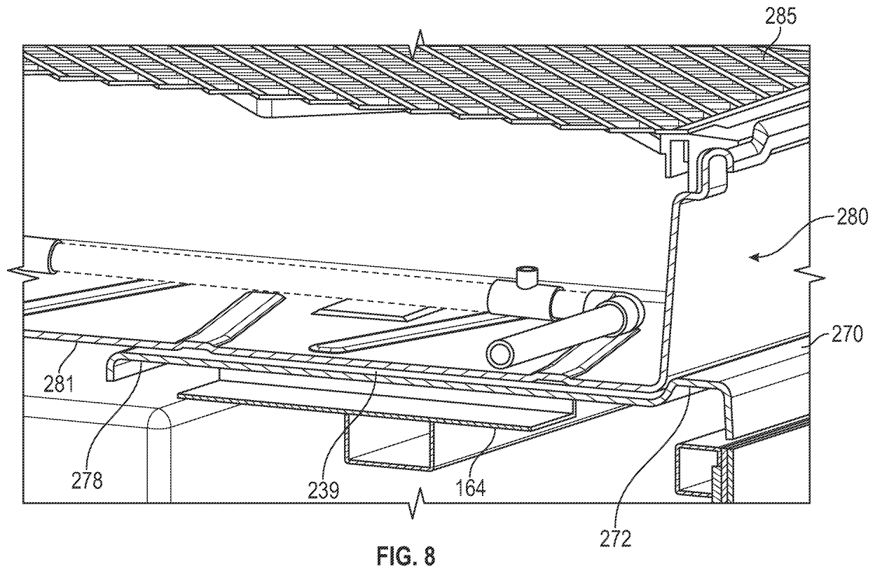

FIG. 8 shows in greater detail the gap 239 between the container bottom surface 281 and non-offset portions of skirt 278 that result from the container bottom 281 contacting the top surfaces of skirt off-sets. The container bottom surface 281 therefore remains spaced from the non-offset portions of skirt 278 along the gap 239. Container 280 can include an opening 372 in container fitting cover 370 for a container fluid fitting 374 (see FIG. 6).

FIG. 9 shows in greater detail the gap 341 between the container bottom surface 281 and surface portions of skirt 378 (see also 341 in FIG. 7B) that results from the container bottom 281 contacting the raised region 330 or top surfaces of stand-offs such as 340 and 344 on the raised region 330. The container bottom surface 281 therefore remains spaced from the surface portions of skirt 378 along the gap 341. Contact between the container bottom 281 and the top surfaces of skirt off-sets or stand-offs such as 340 and 344 on the raised region 330 can result in the separation or gaps 339, 341 between the container drain opening 252, and optional container downspout 250, and skirt drain opening 352. Skirt raised region 330 is shown with rear wall 384 facing channel 324 that can accommodate container drain downspout 250 and a channel 322 facing the front lip 272 that can accommodate container drain downspout 250. Downward sloping angled surface region 354 of skirt 378 that is adjacent the skirt drain opening 352 can direct nutrient fluid to the drain opening and into opening 157 of nutrient drain line 158. In some embodiments of the disclosure the drain opening 252 through the bottom of the container 280 can be separated by distance 339 from the skirt drain by the height of the raised region 330 of the skirt 378. In other embodiments of the disclosure the bottom of the drain downspout 250 of the container 280 can be separated by distance 339 from the skirt drain surface by the height of the raised region 330 of the skirt 378.

As illustrated in FIG. 7A and FIG. 9, the one or more rear skirt portions of the grow system can include a skirt drain opening 352 through a skirt bottom surface or lower skirt side walls near the rear skirt end wall 384. The one or more rear skirt portions can have a raised region or a skirt ramp 330, the raised region or skirt ramp 330 can have a height that may be measured between a top of the skirt raised region or ramp (optionally including stand-offs) and the skirt bottom surface at the drain opening 352. The raised region or skirt ramp (optionally including stand-offs) 330 can have a height above the skirt bottom surface at the skirt drain opening 352 that can offset the container bottom 281 from the skirt bottom surface and create a gap 339 between the container drain opening 252, or container drain downspout 250, and the skirt drain opening 352. The raised region 330 or skirt ramp 330 can be located at the rear skirt side of the one or more skirts. The skirt raised region or skirt ramp 330 can span between the rear skirt sides (as illustrated in FIG. 5). The skirt sides 386 and 382, the raised region 330, and the rear skirt wall 384 can contain and direct the liquids to the skirt drain opening 352. The raised region or ramp near the rear of the skirt and can have a front side facing surface (e.g. 322) and a skirt drain facing surface (e.g. 324). The skirt drain facing surface of the raised region can comprise a channel 324 that slopes toward the skirt drain.

FIG. 10A and FIG. 10B illustrates how grow containers such as 280, and 380 can be removed from the grow system 300 or installed into grow system 300. A container such as 280 can be removed from the grow system by lifting the container front wall and container bottom 281 above the height of the front lip 272, pulling or moving the container forwards at least partially over the front lip 272, and setting the container bottom surface 281 atop the front lip surface 270 (e.g. FIG. 10A). The container 280 can be pulled or moved forward while keeping the drain opening 252 and optionally the drain downspout 250 on the rear facing side of the raised region 330 such that residual liquid in the container 280 can exit the container and travel to the skirt drain opening 352. In some embodiments, pulling or moving the container 280 forward onto the front lip surface 270 can position the front of the container higher than the rear of the container and position the drain opening 252, and optionally the drain downspout 250, between the downward sloping portion 324 of the rear facing side of the raised region 330 and the rear skirt wall 384. The tilting of the container 280 by placing bottom surface 281 on front lip surface 270 can facilitate removing and draining residual liquid in the container 280 to the skirt and skirt drain opening 352. This ensures that residual liquid is drained and removed from the container 280 before removal of the container 280 from the grow system, thereby reducing risk of spillage of the liquid on the user. Advantageously, the container can be lifted less than a quarter of its depth in order to place it on the front lip surface 270.

In some embodiments of the disclosure a method of removing one or more containers such as container 280 from a grow system can include the acts or steps of moving the bottom surface 281 of the container 280 near the front wall 264 of the container from below the front skirt lip surface 270 as shown in FIG. 7B to a position where a portion of the container bottom surface 281 can be placed atop a front lip surface 270 of skirt lip 272 as illustrated in FIG. 10A. In this position atop the front lip surface 270, as further illustrated in FIG. 10A, the container bottom surface 281 at the container front wall 264 is positioned higher than the container bottom surface 281 at the container rear wall 262. The container is tilted from front (higher) to back (lower). In this position the container drain opening 252 can be positioned between the rear facing side of the raised region 330 and the skirt rear wall 384 as shown in FIG. 10A and liquid inside the container 280 can move or flow toward the container drain opening 252 and into the rear skirt drain opening 352. In this position the container drain opening 252 and optional downspout 250 can be positioned between the rear facing side of the raised region 330 and the skirt rear wall 384 as shown in FIG. 10A and separated from the skirt 378 liquid contacting surface (upper surface) by a gap 341 such that liquid inside the container 280 can flow toward the container drain opening 252 and optional downspout and into the rear skirt drain opening 352.

In some embodiments of the method of removing a container 280 from a grow system of the disclosure, the rear facing side of the raised region 330 can be sloped toward the skirt drain opening. The raised region can include a rear facing gap or channel 324 that can be sloped toward the skirt drain opening. The rear facing gap 324 can provide clearance for an optional container downspout 252 to clear the raised region as the container is removed from the skirt and grow system. In still other embodiments the raised region 330 can include a front facing gap or channel 322.

When installing containers into a grow system, a rear end portion of the container 280 near wall 262 can be placed on the skirt front lip surface 270 and between side skirts such as 282 and 286. The container drain opening 252 can be positioned between the skirt front lip 272 and rear wall 384. This positioning of the container can align container drain opening and optional downspout with gaps between skirt stand-offs such as 220 at the front of the skirt. The container 280 can be pushed or moved further into the grow system and between the side skirts 386 and 382 at the rear of the skirt in the grow unit, with the side skirts 386, 382 guiding the container 280 into the grow system in an aligned manner. The container drain opening 252 can be positioned between rear skirt raised portion 330 and rear wall 384 thereby forming a gap 341 between a portion of the container bottom surface 281 and at least a portion of skirt 378 liquid contacting surface. This positioning of the container with the rear portion of the skirt can further align container drain opening 252 (and optional downspout 250) with gaps such as 322 and 324 in the rear skirt raised portion. The container can be pushed or moved into the grow system until the front wall 264 of the container 280 is past front lip 272 and rear wall 262 of container 280 can be in contact or nearly contacting rear skirt wall 384. The container can be pushed or moved into the grow system until the front wall 264 of the container 280 is past front lip 272 (e.g., with the container 280 lowering into an engaged or locked position relative to the recessed area adjacent to the front lip 272) and container fitting 374 can engage the fitting 376 in fluid communication with the nutrient supply.

In embodiments of a method of installing containers into a grow system of the disclosure the method can include the acts or steps of placing a container bottom surface 281 that is near a container rear wall 262 atop the front side skirt lip surface 270 and between side skirts 282 and 286. A container drain opening 252, and optionally downspout 252, of the container can be in-line with one or more gaps 220 between one or more skirt stand-offs 242 at the front of the skirt 278. The drain opening 252 and optional downspout positioned can be positioned between the front lip 272 and the skirt stand-offs 242. The method of installing can further include moving the container 280 into the grow system between the side skirts 382, 386 at a rear of the grow unit until the rear wall 262 of the container is at least past the apex of the rear skirt raised portion 330 whereby a gap 341 is formed or exists between a portion of the container bottom surface 281 and at least a portion of skirt 378 liquid contacting surface (upper surface) as illustrated in FIG. 10A and FIG. 10B.

In some embodiments the method of installing grow containers into the grow system can include positioning the container drain 252 over the skirt drain opening 352. In some embodiments a gap 339 can exit between the skirt surface 354 near the skirt rear wall 384 and skirt drain opening 352 and the container drain opening 252 or container downspout 250 as illustrated in FIG. 9.

In some embodiments the method of installing containers into the grow system can include the acts or steps of positioning the container bottom surface 281 that is near container front wall 264 in contact with a stand-off surface 242 of the skirt that is located between side skirts 282 and 286. The front wall 264 of the container 280 can be past front lip 272 as shown in FIG. 7B. The front wall 264 of the container 280 can be past front lip 272 as shown in FIG. 7B and a container fitting 374 can be connected to a fitting 376 that is in fluid communication with a nutrient supply as shown in FIG. 6.

In some embodiments of methods of installing containers into the grow system, the grow system can include skirts that can have a rear skirt raised portion 330 that has a rear facing gap 324 between the side skirts 382, 386 at the rear of the grow unit. In still other embodiments the raised region 330 can include a front facing gap or channel 322.

FIG. 10A illustrates the downward slope, from front to back, of the growing container 280 when the bottom surface 281 of the container is positioned atop the front lip surface 270. FIG. 10A illustrates the drain opening 252 and optionally the drain downspout 250 positioned between the skirt drain opening 352 and the rear facing side of the skirt raised region 330 such that any liquid in the container 280 can be directed to the skirt drain opening 352 and rear skirt drain downspout 350. In some embodiments, the bottom surface 281 of the container 280 can slope from one or more sides towards the drain opening 252. FIG. 10A illustrates a growing container drain opening 252 through the bottom surface or lower side wall surface of the growing container that can be positioned between the rear side skirt end wall and the drain facing surface of the skirt raised region 330 when the container bottom 281 is positioned on a top surface 270 of the front side skirt lip 272 and between the opposing skirt sides (not shown).

FIG. 11A is a front view of a grow system 300 illustrating one or more levels of grow containers 380, one or more skirts 278, one or more levels of lighting lamps and lighting support frames, base frame portions with panel covers 420, 440, and upper frame portion with panel covers 410, 430. FIG. 11B is a front view of the grow system of FIG. 11A absent lighting lamps, containers, and skirts. Lighting supports 360 and 364 are shown positioned between upper frame portions (e.g. between panel covers 410 and 430), and front skirt supports 164 are shown without the skirts and containers. Front access panels 450 are shown positioned across the base frame portion between cover panel 420 and cover panel 440.

FIG. 12A is a rear view of a grow system 300 illustrating one or more levels of grow containers 280 and 380, one or more levels of skirts 378 and 379, one or more levels of lighting lamps and lighting supports, and base frame portion panels (420, 440) and upper frame panel portions (410, 430). FIG. 12A includes rear access panels 460 positioned across the base frame portion between panel covers 420 and 440. Access panel 462 can optionally be a clear or translucent panel that can cover the grow system filters 470. The clear panel 462 can permit an operator to view pressure gauges to determine filter pressure drop and filter change out. Panel 462 may be omitted. Panel 462 may be substituted by panel 460 where electronic pressure gauges can be used to measure filter pressure drop. Grow system display panel 412 can be used to display various operating aspects of the grow system including but not limited to flow rate, pressure drop, pH, temperature and relative humidity. Controller 414 can be used to adjust grow system operation limits, alarms, lighting recipes, grow cycles, and the like. FIG. 12B is a rear view of the grow system 300 of FIG. 12A with some items omitted including containers, skirts, and lighting lamps. Rear skirt support plates 166 are shown.

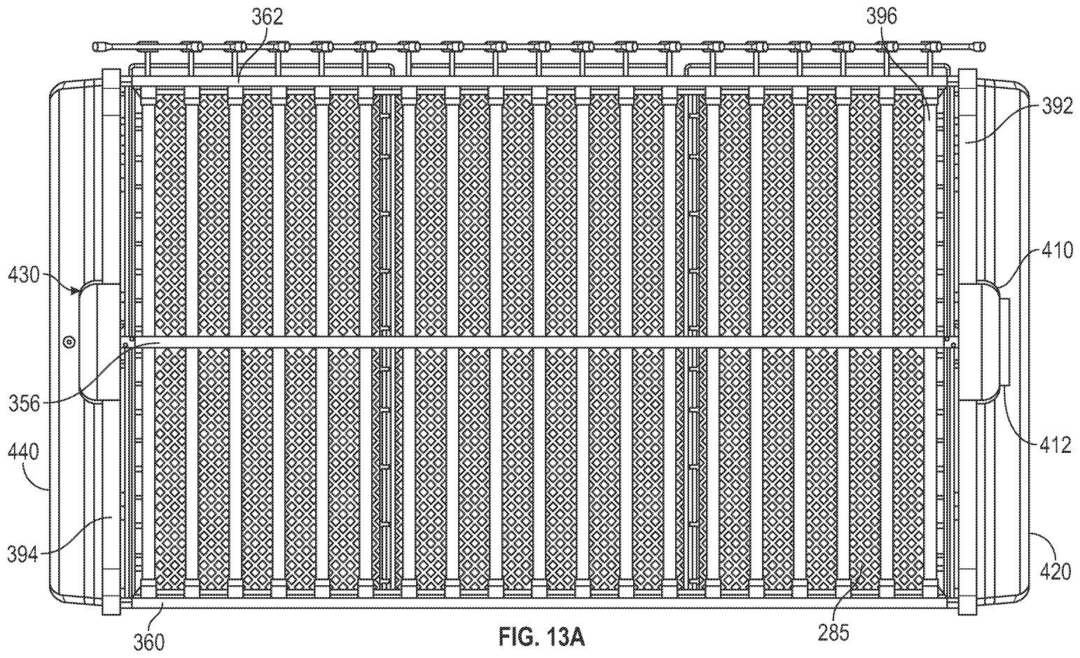

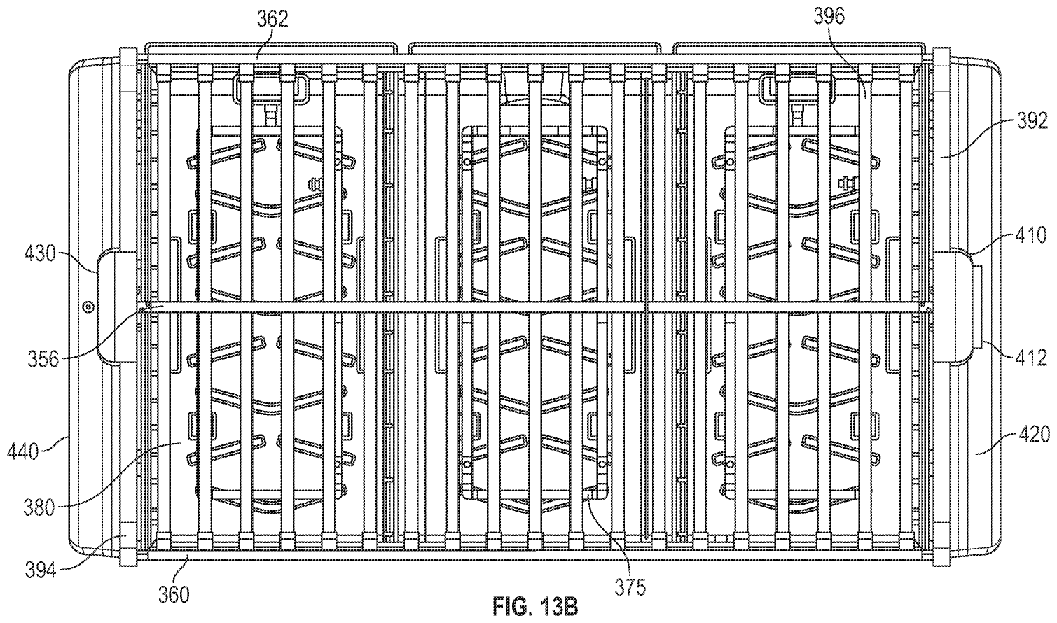

FIG. 13A is a top view of the grow system 300 illustrating top level front lighting support 360, top level rear lighting support 362, and top level lighting lamps 396. Upper level lighting support side frame members 392 and 394 are shown along with top horizontal framing member 356. Upper level growing trays 285 are illustrated positioned below the lighting lamps 396 and are supported by containers (not shown). Base frame panel portions (420, 440) and upper frame panel portion (410, 430) are illustrated along with display 412 on upper frame panel portion 410. FIG. 13B is a simplified top view of the grow system 300 of FIG. 13A. FIG. 13B illustrates top level front lighting support 360, top level rear lighting support 362, and top level lighting lamps 396. Growing containers 380 with an optional fertigation manifold 375 are illustrated (positioned below omitted growing trays 285).

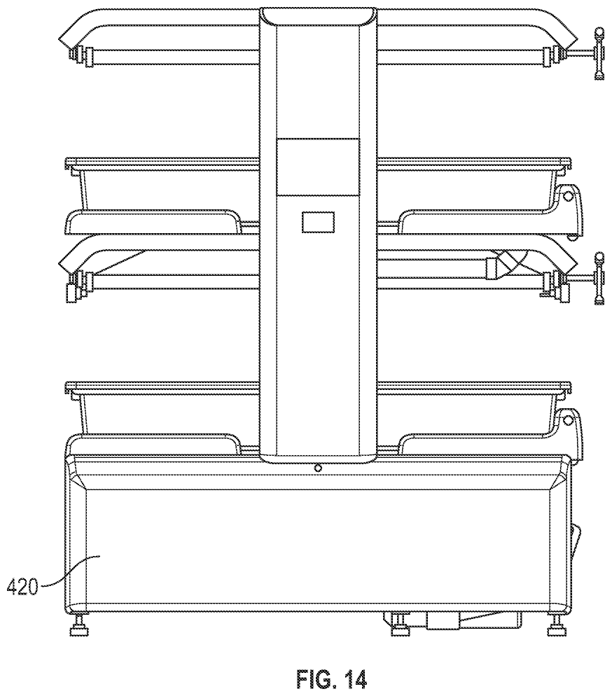

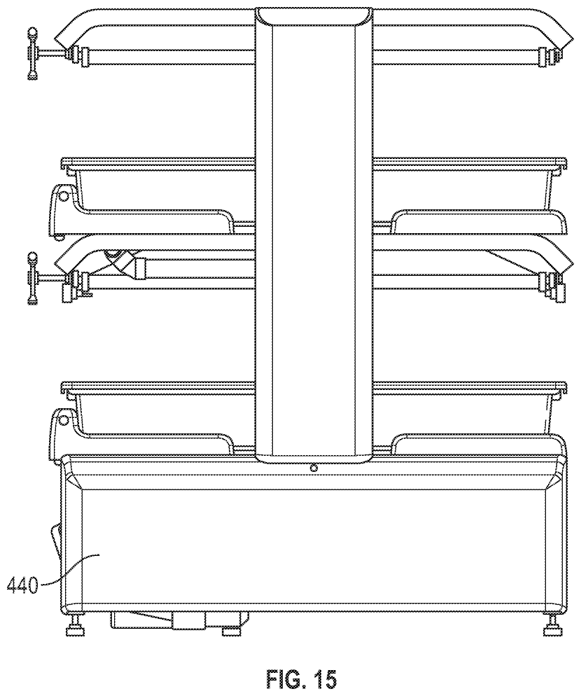

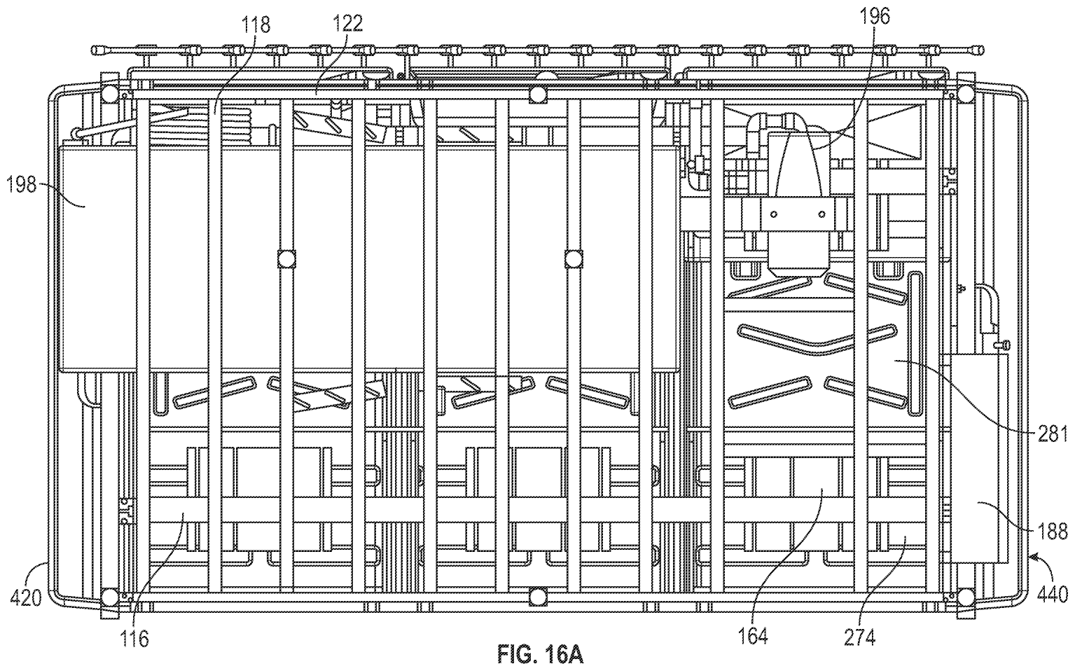

FIG. 14 is a right side view of the grow system 300. FIG. 15 is a left side view of the grow system 300.

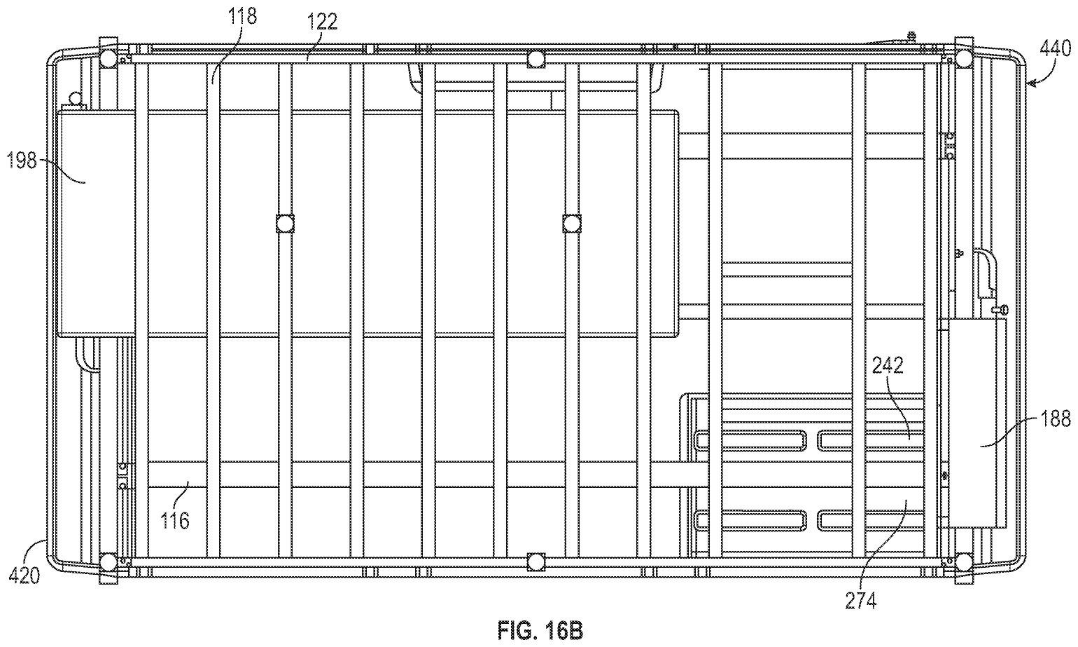

FIG. 16A is a bottom view of the grow system 300 illustrating the base frame portion panel covers (420, 440), horizontal frame members such as but not limited to 116, 118, and 122. Also optionally illustrated are nutrient tank 198 that can be supported by horizontal members 118, a nutrient supply pump 196, and an electrical panel 188. A bottom surface 281 of a container 280 is shown. FIG. 16A also shows skirt 274 positioned overtop of skirt support panel 164 and horizontal framing member 116. FIG. 16B is a simplified bottom view of the grow system 300 in FIG. 16A illustrating the horizontal framing members such as but not limited to 116, 118, and 122, optional electrical panel 188 and nutrient tank 198. FIG. 16B further illustrates the skirt 274 with offset 242 supported by horizontal framing member 116. Base frame portion covers (420, 440) are also shown in FIG. 16B.

The following clauses further define particular aspects and embodiments of the disclosure.

Clause 1. A grow system comprising: a grow system frame comprising a top side, a bottom side, a right side, a left side, a front side, and a rear side; one or more growing containers for developing plants and one or more lighting lamps for developing plants;
the growing system frame having one or more vertical member(s) and one or more horizontal member(s), the vertical member(s) and horizontal member(s) connected together to support one or more levels of the growing containers and one or more levels of the lighting lamps; said one or more growing containers and one or more lighting lamps extend past the vertical members of the grow system frame;
one or more skirts positioned atop the horizontal member(s), said horizontal member(s) connect opposite sides of the growing frame together, the one or more skirts support the growing containers between a front side skirt lip, opposing skirt sides, and a rear side skirt end wall; the rear skirt end wall comprises a nutrient port that connects with a container nutrient inlet port;
the one or more skirts comprise a skirt drain opening through a skirt bottom surface near the rear side skirt end wall; the one or more skirts comprise a skirt raised region, the skirt raised region has a height above the skirt bottom surface at the skirt drain opening that offsets a container bottom surface from the skirt inner bottom surface and creates a gap between a growing container drain opening through a bottom surface of the container and the skirt drain opening, the skirt raised region spans between opposing skirt side walls, the front side skirt lip and the rear side skirt end wall; the skirt raised region has a front side facing surface and a skirt drain facing surface; the growing container drain opening through the bottom surface of the growing container is positioned in the grow system between the rear side skirt end wall and the drain facing surface of the skirt raised region when the growing container is positioned between the front side skirt lip, the opposing skirt sides, and the rear side skirt end wall.

Clause 2. The grow system of clause 1 wherein the front side of the one or more skirts is positioned vertically higher in the grow system than the rear side of the one or more skirts and the growing container in the grow system between the front skirt lip and the rear skirt end wall slopes from the front side of the grow system downward towards the rear side of the grow system.

Clause 3. The grow system as in any one of clauses 1-2, wherein the one or more skirts are pairs of skirts comprising a front skirt and a rear skirt.

Clause 4. The grow system as in any one of clauses 1-3, wherein the one or more skirts are pairs of skirts comprising a front skirt and a rear skirt and the front skirt and rear skirt are separated from each other by a gap.

Clause 5. The grow system as in any one of clauses 1-4, wherein the growing container drain opening through the bottom surface of the growing container is positioned between the rear side skirt end wall and the drain facing surface of the skirt raised region when the container bottom is positioned between the front side skirt lip, the opposing skirt sides, and the rear side skirt end wall.

Clause 6. The grow system as in any one of clauses 1-5, wherein the growing container drain opening through the bottom surface of the growing container is positioned between the rear side skirt end wall and the drain facing surface of the skirt raised region when the container bottom is positioned on a top surface of the front side skirt lip and between the opposing skirt sides and the rear side skirt end wall.

Clause 7. The grow system as in any one of clauses 1-6, wherein the drain opening 252 through the bottom surface of the container is separated from the skirt drain by the height of the rear skirt raised region.

Clause 8. The grow system as in any one of clauses 1-7, wherein the drain opening through the bottom surface of the container further includes a drain downspout that is the same length shorter than the height of the skirt offsets 240, 340 on the skirt inner surface.

Clause 9. The grow system as in any one of clauses 1-8, wherein the drain facing surface of the skirt raised region 330 comprises a channel 324 that slopes toward the skirt drain opening 352.

Clause 10. The grow system as in any one of clauses 1-9, wherein the container drain opening through the bottom surface of the container aligns with the channel of the drain facing surface of the skirt raised region when the container is positioned between side skirts.

Clause 11. The grow system as in any one of clauses 1-10, wherein the distance between the top surface of the raised region offsets 340 and the channel 324 bottom is at least the distance container drain downspout 250 protrudes below container bottom surface 281.

Clause 12. The grow system as in any one of clauses 1-11, wherein the skirt raised region further comprises a lead in channel 322 on a front facing surface of the skirt raised region.

Clause 13. The grow system as in any one of clauses 1-12, wherein the rear skirt portion comprises a downward sloping surface 354 between the skirt rear end wall and the skirt drain opening.

Clause 14. The grow system as in any one of clauses 1-13, wherein a length of the growing container between front skirt lip and rear skirt end wall extends horizontally past the vertical members of the grow system frame that support the lighting lamps and lighting frames.

Clause 15. The grow system as in any one of clauses 1-14, wherein the lighting lamps and lighting frame can extend horizontally over the growing containers.

Clause 16. The grow system as in any one of clauses 1-15, wherein the grow system frame comprises a center portion joined to a base portion and the center portion includes the top side, the bottom side, the right side, the left side, the front side, and the rear side, and whereby the growing container between front skirt lip and rear skirt end wall extends horizontally past the center portion of the grow system.

Clause 17. A grow system comprising:
a grow system frame comprising a top side, a bottom side, a right side, a left side, a front side, and a rear side;
the growing system frame having one or more vertical member(s) and one or more horizontal member(s), the vertical member(s) and horizontal member(s) connected together to support one or more levels of lighting lamps and one or more skirts adapted to hold growing containers; the one or more levels of lighting lamps and one or more levels of skirts extend past the vertical members of the grow system frame;
the one or more skirts positioned atop horizontal member(s) that connect the opposite sides of the growing frame together, the one or more skirts adapted to support the growing containers have a front side skirt lip, opposing skirt sides, and a rear side skirt end wall; the rear skirt end wall comprises a nutrient port adapted to fluidly connect to a container nutrient inlet port;
the one or more skirts further comprise a skirt drain opening through a skirt bottom surface near the rear side skirt end wall; the one or more skirts comprise a skirt raised region between the side skirts, the rear end wall, and the front lip, the raised region adapted to contact a bottom surface of the container, the skirt raised region has a height above the skirt bottom surface at the skirt drain opening that is adapted to create a gap between the skirt drain opening and the bottom surface of the container when the container is positioned between the front side skirt lip and the rear side skirt end wall.

Clause 18. The grow system of clause 17 wherein the front side of the one or more skirts is positioned vertically higher than the rear side of the one or more skirts in the grow system.

Clause 19. The grow system as in any one of clauses 17-18, wherein one or more skirts each comprise a pair of a front skirt and a rear skirt and the front skirt and the rear skirt are separated from each other by a gap.

Clause 20. The grow system as in any one of clauses 17-19, further comprising a growing container, said growing container has a growing container drain opening through the bottom surface of growing container, the growing container drain opening is positioned near and separated from the skirt drain opening when the container is positioned between the front side skirt lip, side skirts, and the rear side skirt end wall.

Clause 21. The grow system of clause 20 wherein the growing containers extend past the vertical members of the grow system frame and greater than a quarter of the total length of the growing containers is accessible from any side of the grow system without interference from a vertical member.

Clause 22. A container skirt adapted for a growing container in a grow system, the container skirt comprising: a front side skirt lip, opposing skirt sides, and a rear side skirt end wall; a skirt drain opening through a skirt bottom surface near the rear side skirt end wall; a skirt raised region between the side skirts, the front side skirt lip and the rear side skirt wall, the raised region adapted to contact a bottom surface of the growing container, the skirt raised region has a height above the skirt bottom surface at the skirt drain opening, the height is adapted to create a gap between the skirt drain opening and the bottom surface of the container when the container is positioned between the front side skirt lip and the rear side skirt end wall.

Clause 23. The container skirt of clause 22 wherein the skirt comprises a front skirt portion and a rear skirt portion, the front skirt portion comprises the front side skirt lip, and the rear skirt portion comprises the rear skirt end wall, the skirt drain opening, and the skirt raised region.

Clause 24. The container skirt of clause 23 wherein the front skirt portion and the rear skirt portion are separate front skirt and rear skirts.

Clause 25. A method of removing a container from a grow system as in any one of clauses 1-16 and clauses 20-21, the method comprising:
lifting a container front wall 264 and a container bottom surface 281 above the height of the front side skirt lip 272;
moving the container front wall 264 towards the front side skirt lip and setting the container bottom surface 281 atop a front lip surface 270 whereby the container bottom surface 281 at the container front wall 264 is positioned higher than the container bottom surface 281 at the container rear wall 262 and the container drain opening 252 is positioned between on a rear facing side of the raised region 330 and skirt rear wall 384 and adapted to transfer liquid inside the container 280 toward the container drain opening 252 and into the rear skirt drain opening 352.

Clause 26. The method of removing a container from a grow system as in clause 25 wherein the rear facing side of the raised region 330 comprises a rear facing gap 324.

Clause 27. The method of removing a container from a grow system as in clause 25 wherein the raised region 330 comprises a sloped rear facing gap 324 and a sloped front facing gap 322.

Clause 28. The method of removing a container from a grow system as in any one of clauses 25-27 wherein the container drain opening 252 further comprises a downspout 252 that extends away from the bottom surface 281 of the container.

Clause 29. A method of installing containers into a grow system as in any one of clauses 1-16 and clauses 20-21, the method comprising:
placing a container bottom surface 281 near a container rear wall 262 atop the front side skirt lip surface 270 and between side skirts 282 and 286; a container drain opening 252 positioned between the skirt front lip 272 and rear wall 384;
moving the container 280 into the grow system between the side skirts 382, 386 at a rear of the grow unit, the container drain opening 252 positioned between rear skirt raised portion 330 and rear wall 384 thereby forming a gap 341 between a portion of the container bottom surface 281 and at least a portion of skirt 378 liquid contacting surface.

Clause 30. The method of installing containers into the grow system of clause 29 wherein moving the container into the grow system a container drain opening 252 is in-line with one or more gaps 220 between one or more skirt stand-offs 242 at the front of the skirt and the drain opening 252 positioned between the front lip 272 and the skirt stand-offs 242.

Clause 31. The method of installing containers into the grow system as in any one of clauses 29-30 wherein moving the container into the grow system a container drain opening 252 is in-line with gap 324 on the rear raised skirt portion 330.

Clause 32. The method of installing containers into the grow system as in any one of clauses 29-31, wherein the moving positions container drain 252 over the skirt drain opening 352.

Clause 33. The method of installing containers into the grow system as in any one of clauses 29-32 wherein the container bottom surface 281 near container front wall 264 contacts stand-off surface 242 between side skirts 282 and 286.

Clause 34. The method of installing containers into the grow system as in any one of clauses 29-33 wherein the front wall 264 of the container 280 bottom surface 281 is between container front lip 272 and rear wall 384 and a container fitting 374 engages a fitting 376 in fluid communication with a nutrient supply.

Clause 35. The method of installing containers into the grow system as in any one of clauses 29-34 wherein the skirt has a downward sloped inner surface 354 between a skirt rear wall 384 and the skirt drain opening 352.

Clause 36. A method of installing containers into the grow system as in any one of clauses 29-35 wherein the rear skirt raised region 330 comprises a rear facing gap 324 between the side skirts 382, 386 at the rear of the grow unit.

Clause 37. A method of installing containers into the grow system as in any one of clauses 29-36 wherein the rear skirt raised portion 330 further comprises a front facing gap 322 between the side skirts 382, 386.

Clause 38. A method of installing containers into the grow system as in any one of clauses 29-37 further comprising a gap 339 between the skirt surface 354 near the skirt drain opening 352 and the container drain opening 252 or container downspout 250.

While the disclosure has been described in detail in connection with only a limited number of aspects and embodiments, it should be understood that the disclosure is not limited to such aspects. Rather, the disclosure can be modified to incorporate any number of variations, alterations, substitutions, or equivalent arrangements not heretofore described, but which are commensurate with the scope of the clauses. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended clauses.

1. A grow system, comprising:
a grow system frame comprising a top side, a bottom side, a right side, a left side, a front side, and a rear side;
one or more growing containers for developing plants and one or more lighting lamps for developing plants;
the growing system frame having one or more vertical member(s) and one or more horizontal member(s), the vertical member(s) and horizontal member(s) connected together to support one or more levels of the growing containers and one or more levels of the lighting lamps, wherein said one or more growing containers and one or more lighting lamps extend past the vertical members of the growing system frame;
one or more skirts positioned atop the horizontal member(s), said horizontal member(s) connect opposite sides of the growing frame together, the one or more skirts support the growing containers between a front side skirt lip, opposing skirt sides, and a rear side skirt end wall; and
the one or more skirts comprise a skirt drain opening through a skirt bottom surface near the rear side skirt end wall; the one or more skirts comprise a skirt raised region, the skirt raised region has a height above the skirt bottom surface at the skirt drain opening that offsets a container bottom surface from the skirt bottom surface and creates a gap between a growing container drain opening through a bottom surface of the container and the skirt drain opening, the skirt raised region spans between and connects the opposing skirt side walls and the skirt raised region has a front side facing surface and a skirt drain facing surface; the skirt raised region is positioned between the opposing skirt side walls, the front side skirt lip and the rear side skirt end wall; the growing container drain opening through the bottom surface of the growing container is positioned between the rear side skirt end wall and the drain facing surface of the skirt raised region when the growing container is positioned between the front side skirt lip, the opposing skirt sides, and the rear side skirt end wall.

2. The grow system of claim 1, wherein the front side of the one or more skirts is positioned vertically higher in the grow system than the rear side of the one or more skirts.

3. The grow system of claim 1, wherein the one or more skirts are pairs of skirts comprising a front skirt and a rear skirt, and the front skirt and rear skirt are separated from each other by a gap.

4. The grow system of claim 3, wherein:
the growing container drain opening through the bottom surface of the growing container is positioned between the rear side skirt end wall and the drain facing surface of the skirt raised region when the container bottom is positioned between the front side skirt lip, the opposing skirt sides, and the rear side skirt end wall; or
the growing container drain opening through the bottom surface of the growing container is positioned between the rear side skirt end wall and the drain facing surface of the skirt raised region when the container bottom is positioned on a top surface of the front side skirt lip and between the opposing skirt sides and the rear side skirt end wall; or
the container drain opening through the bottom surface of the container is separated from the skirt drain by the height of the skirt raised region.

5. (canceled)

6. (canceled)

7. The grow system of claim 3, wherein:
the container drain opening through the bottom surface of the container further comprises a drain downspout that extends from the container bottom surface a distance less than the height of the skirt offsets on the skirt surface;
the drain facing surface of the skirt raised region comprises a channel that slopes toward the skirt drain opening;
the channel of the drain facing surface of the skirt raised region aligns with the container drain opening through the bottom surface of the container when the container is positioned between side skirts; and
a distance between the top surface of the raised region offsets and the channel bottom is at least a distance the container drain downspout extends below container bottom surface.

8. (canceled)

9. (canceled)

10. (canceled)

11. A grow system, comprising:
a grow system frame comprising a top side, a bottom side, a right side, a left side, a front side, and a rear side;
the growing system frame having one or more vertical member(s) and one or more horizontal member(s), the vertical member(s) and horizontal member(s) connected together to support one or more levels of lighting lamps and one or more skirts adapted to hold growing containers; the one or more levels of lighting lamps and one or more levels of skirts extend past the vertical members of the grow system frame;
the one or more skirts positioned atop horizontal member(s) that connect the opposite sides of the growing frame together, the one or more skirts adapted to support the growing containers have a front side skirt lip, opposing skirt sides, and a rear side skirt end wall; and
the one or more skirts further comprise a skirt drain opening through a skirt bottom surface near the rear side skirt end wall; the one or more skirts comprise a skirt raised region between the side skirts and adapted to contact a bottom surface of the container, the skirt raised region has a height above the skirt bottom surface at the skirt drain opening that is adapted to create a gap between the skirt drain opening and the bottom surface of the container when the container is positioned between the front side skirt lip and the rear side skirt end wall.

12. The grow system of claim 11, wherein:
the front side of the one or more skirts is positioned vertically higher than the rear side of the one or more skirts; and
one or more skirts comprise a front skirt and a rear skirt and the front skirt and the rear skirt are separated from each other by a gap.

13. (canceled)

14. The grow system of claim 12, further comprising a growing container, said growing container has a growing container drain opening through the bottom surface of growing container, the growing container drain opening is positioned near and separated from the skirt drain opening when the container is positioned between the front side skirt lip, side skirts, and the rear side skirt end wall.

15. A container skirt adapted for a growing container in a grow system, the container skirt comprising:
a front side skirt lip, opposing skirt sides, and a rear side skirt end wall;
a skirt drain opening through a skirt bottom surface near the rear side skirt end wall; and
a skirt raised region between the side skirts adapted to contact a bottom surface of the growing container, the skirt raised region has a height above the skirt bottom surface at the skirt drain opening the height is adapted to create a gap between the skirt drain opening and the bottom surface of the container when the container is positioned between the front side skirt lip and the rear side skirt end wall.

16. The skirt of claim 15, wherein:
the skirt comprises a front skirt portion and a rear skirt portion, the front skirt portion comprises the front side skirt lip, and the rear skirt portion comprises the rear skirt end wall, the skirt drain opening, and the skirt raised region; and
the front skirt portion and the rear skirt portion are separate front skirt and rear skirts.

17. (canceled)

18. A method of removing a container from a grow system as in claim 11, the method comprising:
lifting a container bottom surface near container front wall above the height of the front side skirt lip;
moving the container front wall towards the front side skirt lip and setting the container bottom surface atop a front lip surface, whereby the container bottom surface near the container front wall is positioned higher than the container bottom surface near the container rear wall, the container drain opening positioned between a rear facing side of the raised region and the skirt rear wall; and
flowing liquid inside the container toward the container drain opening and into the rear skirt drain opening.

19. The method of claim 18, wherein:
the rear facing side of the raised region comprises a rear facing gap; or
the raised region comprises a sloped rear facing gap and a sloped front facing gap; or
the container drain opening further comprises a downspout that extends away from the bottom surface of the container.

20. (canceled)

21. (canceled)

22. A method of installing containers into a grow system as in claim 11, the method comprising:
placing a container bottom surface near a container rear wall atop the front side skirt lip surface and between side skirts, a container drain opening in-line with one or more gaps between one or more skirt stand-offs at the front of the skirt and the drain opening positioned between the front lip and the skirt stand-offs; and
moving the container into the grow system between the side skirts at a rear of the grow unit and at least past skirt raised portion, whereby a gap is formed between a portion of the container bottom surface and at least a portion of skirt liquid contacting surface.

23. The method of claim 22, wherein:
the moving positions container drain opening over the skirt drain opening; and
a gap forms between the skirt surface near the skirt drain opening and the container drain opening or container downspout.

24. The method of claim 22, wherein:
the container bottom surface near container front wall contacts stand-off surface between side skirts, or
the front wall of the container is positioned between skirt front lip and skirt rear wall and engaging a container fitting with a fitting in fluid communication with a nutrient supply; or
the skirt has a downward sloped surface between a skirt rear wall and the skirt drain opening; or
the rear skirt raised region comprises a rear facing gap between the side skirts at the rear of the grow unit.

25. (canceled)

26. (canceled)

27. (canceled)

28. (canceled)

29. A grow system, comprising:
a grow system frame comprising a top side, a bottom side, a right side, a left side, a front side, and a rear side;
one or more growing containers for developing plants and one or more lighting lamps for developing plants;
the growing system frame having one or more vertical member(s) and one or more horizontal member(s), wherein said one or more growing containers extend past the vertical members of the growing system frame; and
one or more skirts positioned atop the horizontal member(s).

30. The grow system of claim 29, wherein:
the vertical member(s) and horizontal member(s) are connected together to support one or more levels of the growing containers and one or more levels of the lighting lamps; or
the one or more lighting lamps extend past the vertical members of the growing system frame; or
the one or more growing containers extend past a vertical plane defined by the vertical members of the growing system frame; or
said horizontal member(s) connect opposite sides of the growing frame together, and the one or more skirts support the growing containers between a front side skirt lip, opposing skirt sides, and a rear side skirt end wall.

31. (canceled)

32. (canceled)

33. (canceled)

34. The grow system of claim 29, wherein:
the one or more skirts comprise a skirt drain opening through a skirt bottom surface near the rear side skirt end wall; and
the one or more skirts comprise a skirt raised region, the skirt raised region has a height above the skirt bottom surface at the skirt drain opening that offsets a container bottom surface from the skirt bottom surface and creates a gap between a growing container drain opening through a bottom surface of the container and the skirt drain opening.

35. (canceled)

36. The grow system of claim 35, wherein:
the skirt raised region spans between and connects the opposing skirt side walls and the skirt raised region has a front side facing surface and a skirt drain facing surface;
the skirt raised region is positioned between the opposing skirt side walls, the front side skirt lip and the rear side skirt end wall; and
the growing container drain opening through the bottom surface of the growing container is positioned between the rear side skirt end wall and the drain facing surface of the skirt raised region when the growing container is positioned between the front side skirt lip, the opposing skirt sides, and the rear side skirt end wall.

37. (canceled)

38. (canceled)

39. A grow system, comprising:
a grow system frame comprising a top side, a bottom side, a right side, a left side, a front side, and a rear side;
the growing system frame having one or more vertical member(s) and one or more horizontal member(s);
one or more levels of lighting lamps and one or more levels of skirts extending past the vertical members of the growing system frame; and
the one or more skirts further comprise a skirt drain opening through a skirt bottom surface near the rear side skirt end wall.

40. The grow system of claim 39, wherein:
the vertical member(s) and horizontal member(s) are connected together to support the one or more levels of lighting lamps and the one or more skirts; or
the one or more skirts are positioned atop the horizontal member(s) that connect the opposite sides of the growing frame together; or
the skirts have a front side skirt lip, opposing skirt sides, and a rear side skirt end wall.

41. The grow system of claim 39, wherein:
the skirts are adapted to hold growing containers;
the skirts comprise a skirt raised region between the side skirts and are adapted to contact a bottom surface of the growing container; and
the skirt raised region has a height above the skirt bottom surface at the skirt drain opening that is adapted to create a gap between the skirt drain opening and the bottom surface of the container when the container is positioned between the front side skirt lip and the rear side skirt end wall.

42. (canceled)

43. (canceled)

44. (canceled)

45. (canceled)
